(19) United States
(12) Patent Application Publication
(10) Pub. No.: US 2026/0362084 A1
(43) Pub. Date: Nov. 12, 2026

(54) ELECTRONIC INFRASTRUCTURE FOR DIGITAL DISCOVERY OF OFF-LINE IDENTITIES

(71) Applicant: Z Guide LLC, San Juan, PR (US)

(72) Inventors: Roberto ZAYAS, San Juan, PR (US); Niraj KUMAR, Guaynabo, PR (US); Mariia KAPINOS, Guaynabo, PR (US)

(21) Appl. No.: 19/647,801

(22) Filed: Apr. 14, 2026

Related U.S. Application Data
(63) Continuation of application No. 18/370,860, filed on Sep. 20, 2023, now abandoned.
(60) Provisional application No. 63/408,347, filed on Sep. 20, 2022.

(51) Int. Cl. H04W 4/021; G06Q 10/42; H04L 67/306

(52) U.S. Cl. CPC H04W 4/021; G06Q 10/42; H04L 67/306

(57) ABSTRACT

Disclosed are a platform and related service that provide users location information, both historical and real-time, of social prospects a user desires to meet. A user searches for potential social prospects based on characteristics desirable to the user. Search results are presented to the user in the form of locations historically and/or currently having social prospects that match some or all of the user's desired characteristics for their social prospects. Search results may include the identification and geographic location of potentially matching social prospects to assist the user in going out to meet these prospects. A specialized rating system for the platform or service is also disclosed, which can assist users with finding bout matching locations and prospects. A “social prospect” may be any person whom a user desires to meet in-person for any of a number of social-based reasons, which may include for romantic reasons, business reasons, friendly reasons, etc.

### PRIORITY CLAIM AND RELATED APPLICATIONS

The present disclosure is a non-provisional conversion of, and thus claims priority to, U.S. Provisional Patent Application No. 63/408,347, filed Sep. 20, 2022, the entirety of which is incorporated herein by reference for all purposes.

### TECHNICAL FIELD

The present disclosure relates in general to the field of in-person social networking, and more particularly to a platform and related service or process for providing location information, both historical and real-time, of social prospects for users.

### BACKGROUND

For many years, social media applications, social networking websites, and messaging applications have been created to assist people to interconnect with other people with whom they presumably have some common interest(s). Typically, such conventional platforms and services function by having users of the platform or service create a profile that includes a number of details about themselves and their interests in the hope that other users find them when searching for such characteristics. Similarly, on other conventional platforms or services, the user searches for potential social prospects based on their desired search criteria. Thus, “matches” between users and potential social prospects are provided based on matching one or more such characteristics and/or interests. Moreover, such searches may also be limited to potential social prospects that are within a geographically desirable area of the searching user.

However, in such conventional platforms or services, communication or even meeting potential social prospects is limited to those situations where matching prospects agree to have direct contact with the searching user, typically via the platform or service. As a result, a searching user can only “meet” potential social prospects if they reply to attempts by the searching user to contact them. Accordingly, what is needed in the art is a socialization platform or related service that permits users to not only search for potential social prospects that match the searching user's desirable criteria, but also provides a searching user a means for determining where potential social prospects could be located so that they can meet them in person without the requirement that prospects first communicate with the user. The disclosed principles provide such a socialization platform or service.

### SUMMARY

In order to overcome the deficiencies of the prior art, the disclosed principles a platform and related service that provide users location information, both historical and real-time, of social prospects, who are other users of the platform or service, a searching user desires to meet. Using the platform or service, a searching user searches for potential social prospects based on characteristics desirable to the searching user. Search results are presented to a searching user in the form of establishments/locations historically and/or currently having social prospects that match some or all of the searching user's desired characteristics for their social prospects. Search results are alternatively presented to a searching user in the form of social prospects that match some or all of the searching user's desired characteristics for their social prospects, and who are currently located at an establishment. As used herein, the term “social prospect” means any person whom a user desires to meet in-person for any of a number of social-based reasons. These may include, but are not limited to, one or more people a user seeks to meet for romantic reasons, business reasons, friendly reasons, etc. Thus, the term social prospect is not intended to be limited to a particular person, gender, occupation, age, race, religious, sexual orientation, etc., but instead is intended to be broad enough to encompass any person who is capable of meeting in-person with a user.

Search results may be filtered using a unique rating factor pertaining to how likely or unlikely social prospects matching the searching user's desired characteristics will be or are at a specific location. This rating factor may be comprised of an objective component based on data gathered by the platform or service pertaining to the characteristics desired by a searching user of social prospects at a specific location, and a subjective component based on data provided by other users of the platform or service also pertaining to those characteristics desired by a searching user of social prospects at a specific location. As a result, this rating factor changes based on the specific characteristics of social prospects a specific user is searching for based on the density of prospects at a specific location that match those specific characteristics.

### BRIEF DESCRIPTION OF THE DRAWINGS

For a more complete understanding of the present invention and its advantages, reference is now made to the following description and the accompanying drawings, in which:

FIG. 1 illustrates a system-level block diagram of a social networking system 100 in accordance with an embodiment of the disclosed principles;

FIG. 2 illustrates a screen view of a login screen 200 for a platform or service in accordance with an embodiment of the disclosed principles;

FIG. 3A illustrates a screen view of an account screen 300A for a platform or service in accordance with an embodiment of the disclosed principles;

FIG. 3B is a screen view illustration of a personal profile screen 300B for a platform or service in accordance with an embodiment of the disclosed principles;

FIG. 3C is a screen view illustration of a social media account screen 300C for a platform or service in accordance with an embodiment of the disclosed principles;

FIG. 4 is a screen view illustration of a user interface having a search screen 400 for a platform or service in accordance with an embodiment of the disclosed principles;

FIG. 4A is a screen view illustration of an additional search criterion 400A that may be include with a search screen 400 such as the screen of FIG. 4;

FIG. 5 is a screen view illustration of a search result detail screen 500, which may be among the results of a search conducted using the user interface of FIG. 4;

FIG. 6A is a screen view illustration of a Check In feedback screen 600A that may be employed by a user of a platform or service in accordance with an embodiment of the disclosed principles;

FIG. 6B illustrates a screen view of an additional Check In screen 600B;

FIG. 7A is a screen view illustration of a User Management screen 700A accessible by an administrator of a platform or service in accordance with an embodiment of the disclosed principles;

FIG. 7B is a screen view illustration of a Location Data Feed screen 700B accessible by an administrator or user of a platform or service in accordance with an embodiment of the disclosed principles;

FIG. 7C is a screen view illustration of a close up view 700C of a dropdown menu for selecting an establishment type from the Location Data Feed screen of FIG. 7B;

FIG. 7D is a screen view illustration of an Establishment Sub-Type selection screen 700D;

FIG. 8A is a screen view illustration of a Promoted Locations screen 800A accessible by a user of a platform or service in accordance with an embodiment of the disclosed principles;

FIG. 9 illustrates a block diagram of a social networking system 900 incorporating a platform or system in accordance with an embodiment of the disclosed principles;

FIG. 10 illustrates a block diagram of a social networking system database 1000 for use with a platform or service in accordance with an embodiment of the disclosed principles;

FIG. 11 illustrates a block diagram of a social networking location database 1100 for use with a platform or service in accordance with an embodiment of the disclosed principles;

FIG. 12 illustrates a block diagram of a social networking user database system 1200 for use with a platform or service in accordance with an embodiment of the disclosed principles;

FIGS. 13A-13C illustrate exemplary screenshots of various account login and signup options from a mobile device application for use with a platform or service in accordance with the disclosed principles;

FIG. 14A illustrates an exemplary screenshot from a mobile application of an interactive map presenting establishments matching search criteria of a user of the mobile application;

FIG. 14B illustrates an exemplary screenshot from a mobile application of a list of establishments matching search criteria of a user of the mobile application;

FIG. 15A illustrates an exemplary screenshot from a mobile application of an interactive map presenting social prospects matching search criteria of a user of the mobile application;

FIG. 15B illustrates an exemplary screenshot from a mobile application of a list of social prospects matching search criteria of a user of the mobile application;

FIG. 16A illustrates an exemplary screenshot from a mobile application of details associated with a single establishment matching search criteria of a user of the mobile application, and selected by the user;

FIG. 16B illustrates an exemplary screenshot from the mobile application of FIG. 16A of a detailed “Check In” screen of the mobile application;

FIG. 16C illustrates an exemplary screenshot from a mobile application of a “Check out” feature associated with a single establishment matching search criteria of a user of the mobile application;

FIG. 17 illustrates an exemplary screenshot from a mobile application presenting a user of the mobile application an option to integrate one or more social media profiles of the user;

FIG. 18 illustrates an exemplary screenshot from a mobile application presenting a user of the mobile application an option to have an Artificial Intelligence engine determine profile details on behalf of the user;

FIG. 19 illustrates an exemplary screenshot from a mobile application presenting a user of the mobile application selection options from available search criteria for finding social prospects;

FIG. 20 illustrates an exemplary screenshot from a mobile application of the profile page of the user of the application who has checked in at a particular establishment;

FIG. 21 illustrates an exemplary screenshot from a mobile application of a QR Code associated with the user of the mobile application;

FIG. 22 illustrates an exemplary screenshot from a mobile application presenting the user of the mobile application a profile of a social prospect matching the search criteria of the user as well as their current location at an establishment;

FIG. 23 illustrates an exemplary screenshot from a mobile application presenting the user of the mobile application a public profile of the social prospect of FIG. 22; and

FIG. 24 illustrates an exemplary screenshot from a mobile application of a messaging feature for the user of the mobile application to communicate with potential social prospects associated with a platform or service as disclosed herein.

### DETAILED DESCRIPTION

The following detailed description includes exemplary embodiments of the inventive principles disclosed herein, and reference is made to the accompanying figures that form a part hereof. The figures here are shown to illustrate specific embodiments in which the disclosed inventive principles may be practiced. Thus, it should be understood that other embodiments will be utilized that may include structural changes and modifications made without departing from the scope of the presently disclosed principles.

### Overview

As discussed above, exemplary embodiments of the disclosed principles provide platforms and services that allow a user to provide search criteria for the type of person or persons he or she would like to meet in-person. For example, if the user would like to meet females that are single, within a desired age range, of a selected ethnicity and/or race, and within a selected geographic location, a platform or service as disclosed herein may provide a geographic display of locations within the selected geographic search area having a concentration of people who meet the user's search criteria. Moreover, a disclosed platform or service may provide temporal search results to the user, such as when people matching the user's search criteria would be (or have been) at geographic locations within the user's search area. A user may thus use such search results to travel to presented locations previously or currently having a concentration of such matching people, thus increasing the likelihood that the user will be able to meet matching people in person.

In exemplary embodiments, users employ an application executing on each user's mobile device, where this plurality of mobile applications are in communication with a centralized platform. In some embodiments, one or more users may instead communicate with the centralized platform via a network interface, such a web browser executing on the user's computing device and communicating with the platform via a computer network such as the internet.

The disclosed principles, embodied in a platform or service, leverage databases of personal information corresponding to search parameters of users to provide geographic locations of people matching selected search parameters, thus ensuring users may meet such matched people in person at the revealed locations. This could include searching for potential social prospects that not only include possible dating or other romantic interest, but could also include search for prospects for business purposes, searching for playmates for a user's children, searching for prospects who have similar interests in a sport or activity, and any other type of social prospect. As mentioned above, large numbers of databases exist that store demographic data of individual people. While a number of databases exist that provide general data such as a person's name, gender, address, and telephone number, there are also databases that store much more personal demographic data that are not typically used by conventional computer-based platforms, systems, or services. Such more atypical demographic data includes people's age, income, marital status, prior marital history, race, ethnicity, height, weight, body dimensions, body-mass index, hair color, eye color, skin color, religious affiliation, occupation, number of children, credit score, income, outstanding debt, debt to income ratio, property ownership, involvement in past or present legal proceedings and in what capacity, judgements against, judgements in favor of, and other more personal details than the typical data used by conventional systems and services. The disclosed principles can employ all such databases having personal information regarding potential social prospects that a user may want to meet if they match most or all of the user's desired characteristics.

However, many of these demographic details are precisely the details that people may want to know when looking to meet people in-person in a social situation. Importantly, many of these demographic details are the details that many people will tend to lie or exaggerate about in an effort to broaden their chances of meeting other people that meet their own search criteria, even though that might be inconsiderate of the desires of people they are hoping to meet. In other cases, some potential prospects or targets may simply have an unrealistic self-view. As a result, if such more personal demographic details were objectively verifiable, then the likelihood that a user meets someone actually matching the criteria they are searching for may be increased, and in many cases guaranteed.

Additionally, the disclosed principles can further leverage real-time feedback data to provide additional accuracy or specificity in search results provided via the platform or service. In one embodiment, feedback may be provided by users in order to confirm that the search results provided to a user are accurate. In such embodiments, a user/reviewer may provide real-time information to a platform or service as disclosed herein, such as through their mobile application or via a website affiliated with the platform or service. Also, such users may be specially designated as authorized reviewers by a platform as disclosed herein; however, in other embodiments such reviewers are simply random and voluntary. In some embodiments, such reviewers may actually be the “targets” users are hoping to meet using the disclosed principles. In such embodiments, these reviewer/targets matching a user's search criteria can confirm that they are at a location provided to a searching user through the disclosed principles. Confirmation of a feedback provider's location may also be confirmed using geolocation. For example, geolocation data provided by a provider's mobile device executing a mobile application associated with a disclosed platform or service can provide such confirmation of geographic location, as well as the provider's location at the time they are providing the feedback. In some embodiments, the provider(s) of feedback to the platform or service may be one or more of the locations that are searchable by querying users of the platform or service, such as provided by agents affiliated with the specific locations.

In some embodiments employing data provided by such various types of reviewers, a feedback interface accessed by such a reviewer may present predetermined demographic fields to which the reviewer provides information. Also, demographic data may be provided for each of several categories of people. For example, for a category such as “females”, demographic data that may be provided by a reviewer could include the age, race, ethnicity, body size, style of dress, attractiveness, etc. that each specific reviewer perceives of the “females” he or she actually sees at that location. Similarly, for the category of “males”, demographic data that may be provided by a reviewer could include the age, race, ethnicity, body size, style of dress, attractiveness, etc. that each specific reviewer perceives of the “males” he or she actually sees at that location. In this respect, a platform or service in accordance with the disclosed principles may employ subjective data to assist in providing accurate search results to users. Additionally, the actual number, or an estimate thereof, of “females” or “males” a reviewer actually sees at a given location may also be provided, thus providing further details for a search user employing the platform or service.

In yet other embodiments, a category of “children” may be provided to a reviewer, in those situations in which a user is searching for social prospects that are children who their own child or children may meet and play with. In such embodiments, the demographic information may include the age of children at the location, the approximate number of male versus female children, the level of activities of the children, and other information the reviewer may perceive at a given location. In still other embodiments, the social prospects searched by a user may be for business network or other business interests, or even for participating together in a common sport or activity. Reviewers can therefore also provide real-time feedback to searching users to confirm whether social prospects the user is searching for, and having the specific criteria desired by the user, are in fact present at geographic locations presented as search results to the searching user. As before, geolocation data associated with the reviewer's physical location, such as via their mobile device executing an application associated with a disclosed platform or service, may again be used to confirm the reviewer's location when providing such feedback.

### Exemplary System and Platform

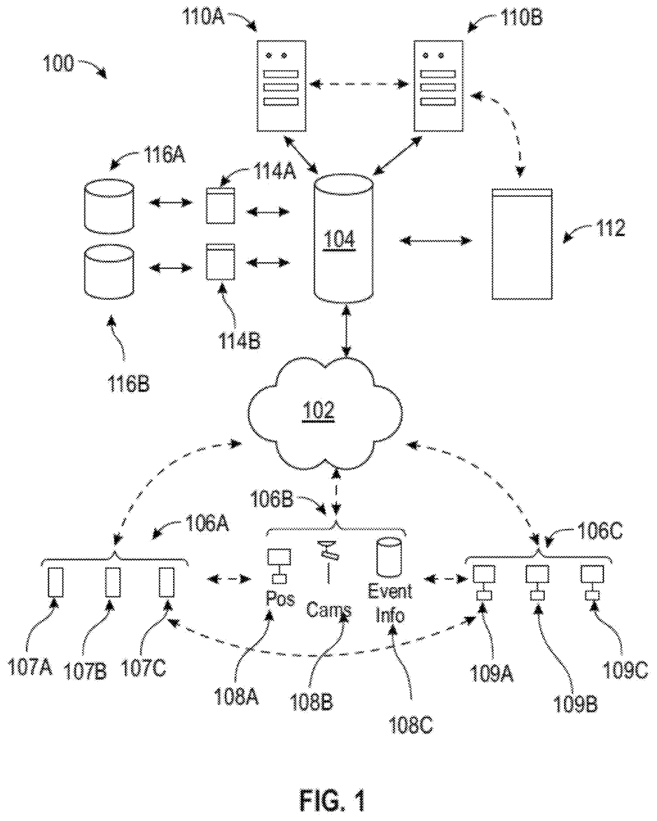

FIG. 1 illustrates a system-level block diagram of a social networking system 100 in accordance with one embodiment of the disclosed principles. A social networking system 100 as disclosed herein can allow for individuals or users to connect, interact with, and/or engage with companies, targets of interest, and/or other individuals or users that comprise possible social prospects having characteristics desired by the searching user. In some examples, a social networking system 100 may be implemented using a plurality of mobile applications running on users' individual computing devices or mobile computing devices, or using access via a website via users' computing devices. The social networking system 100 can include at least one database 104 that can be connected via a network 102. The network 102 may include packet-based networks, and/or other types of network equipment and components that allow for the transmission of data, images, video, audio, and other file types or formats. Similarly, such a database 104 can be configured to store and/or categorize data, images, video, audio, and/or other file types or formats. The database 104 may be any type of database, and can include but is not limited to sequel, non-sequel, centralized, distributed, cloud, relational, network, object-oriented, hierarchical, and/or other types or styles of databases.

The database 104 can be coupled to any number of devices and/or computing systems. For example, via the network 102, the one or more databases 104 may be coupled to mobile computing devices 106A, network connected devices 106B, and/or computing devices 106C (collectively device systems 106). In some examples, the mobile computing devices 106A can include, but are not limited to, mobile phones 107A, mobile computers, smartphones 107B, personal digital assistants (PDAs), media players, tablets 107C, and/or other devices containing at least one controller or processor and being able to connect to at least one computer-based network. Such mobile devices may each be executing a mobile application configured to communicate with a platform as disclosed herein, or are part of a type of disturbed platform or service as disclosed herein. Similarly, computing devices 106C may include, but are not limited to, desktop computers 109A, laptop computers 109B, convertible computers 109C, tablet computers, and/or other devices having at least one processor and being able to connect to at least one computer-based network in order to communication with a disclosed platform. Still further, in an advantageous embodiment, a platform as disclosed herein comprises a plurality of mobile applications executing on a corresponding plurality of user, reviewer, and/or social prospect mobile devices, where each of those applications are in communication with the platform, which may comprise one or more databases, one or more servers, one or more processors, via a communications network.

Additionally, there the system 100 can include network-connected devices 106B, such as but not limited to security systems, point of sale (POS) systems 108A, camera systems 108B, ticket or event management systems 108C, sensor systems, credit card payment systems, or other devices that are capable of being connected through a computer-based network. In at least one example, these network connected devices 106B may include a processor or controller to allow for processing or control of the data, images, video, audio, and/or other file types or formats that can be transmitted by the network connected devices 106B. The network connected devices 106B, in some examples, may include the ability to be edge-processed to allow for the transmission of pre-processed and/or categorized data, images, video, audio, and/or other file types or formats.

The device systems 106 may be connected via the network 102 to the at least one database 104 and server(s) 110A/110B. In at least one example, the database 104 may be stored and/or operated through server(s) 110A and/or 110B (collectively servers 110). The servers 110 may have at least one processor, at least one memory storage device, at least one data storage device, a network connection and/or transceiver, and/or an input/output bus device. The servers 110 may process and/or analyze the data, images, video, audio, and/or other file types or formats prior to or after storage within the at least one database 104. For example, the servers 110 may process data, images, video, audio, and/or other file types or formats as it is placed and/or stored within the at least one database 104, to allow for categorization and/or tagging to the data, images, video, audio, and/or other file types or formats. A data organization system 112 can filter, tag, and/or categorize data, images, video, audio, and/or other file types or formats within the at least one database 104. The servers 110 may utilize the data organization system 112 to process and/or analyze the data, images, video, audio, and/or other file types or formats as it is received and/or after it is stored within the at least one database 104. One or more of the servers 110, databases 104, and data organization system 112, as well as one or more other devices and/or components of the system 100, may work together to provide a platform or service as disclosed herein.

Additional data sources 116A and/or 116B may be utilized to provide context and/or supplement the data, images, video, audio, and/or other file types or formats stored within the at least one database 104. For example, Global Positioning System (GPS) data may be supplemented with weather data to provide additional information that may allow for users to make additional decisions. In at least one example, the additional data sources 116A and/or 116B may have source filters 114A/114B that allows for specific information to be provided. For example, a data source may provide 1000 lines of data, but the source filters 114A/114B may reduce the data down to 100 lines of usable data. Additional details of exemplary data sources that may be accessed for use by a platform or service in accordance with the disclosed principles are discussed below.

### Platform and Service Interfaces

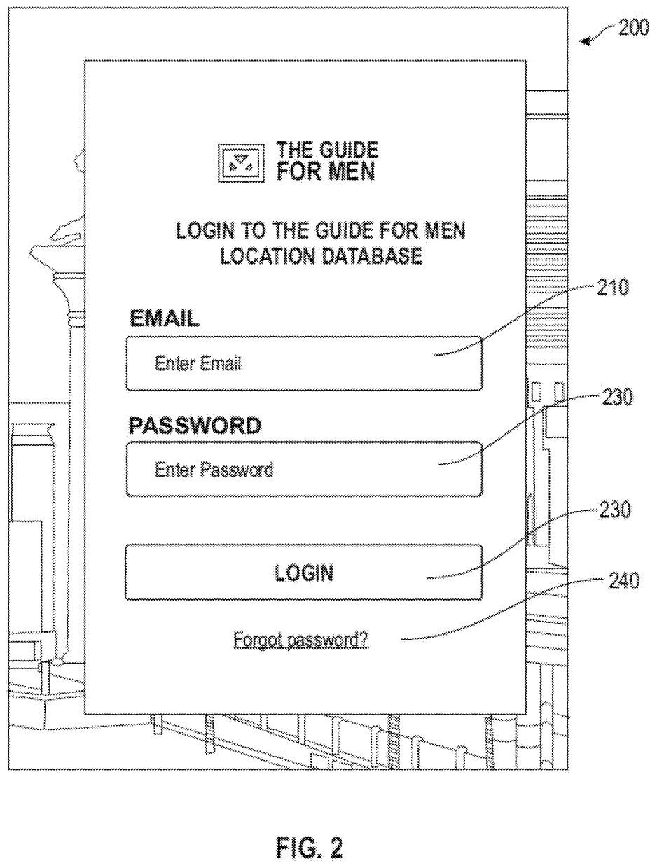

FIG. 2 illustrates a screen view of a login screen 200 for a platform or service in accordance with an embodiment of the disclosed principles. The login screen 200 is used to prevent unauthorized access to a program, application (or “app”), or website used to access a disclosed platform or service. A User ID 210 may be utilized as part of multi-layer access process, where the User ID 210 may be an email or username used or created by a user. Additionally, users may provide a password 220 as part of the multi-layer access process. Once a user has provided these credentials via the login screen 200, the user may click on a login button 230. Alternatively, if a user has forgotten their username and/or password, the user may click a “Forgot Password” or other similar link 240 to access another page, window, or module that may require additional information to be entered or provided by the user in order to retrieve all or part of their login credentials.

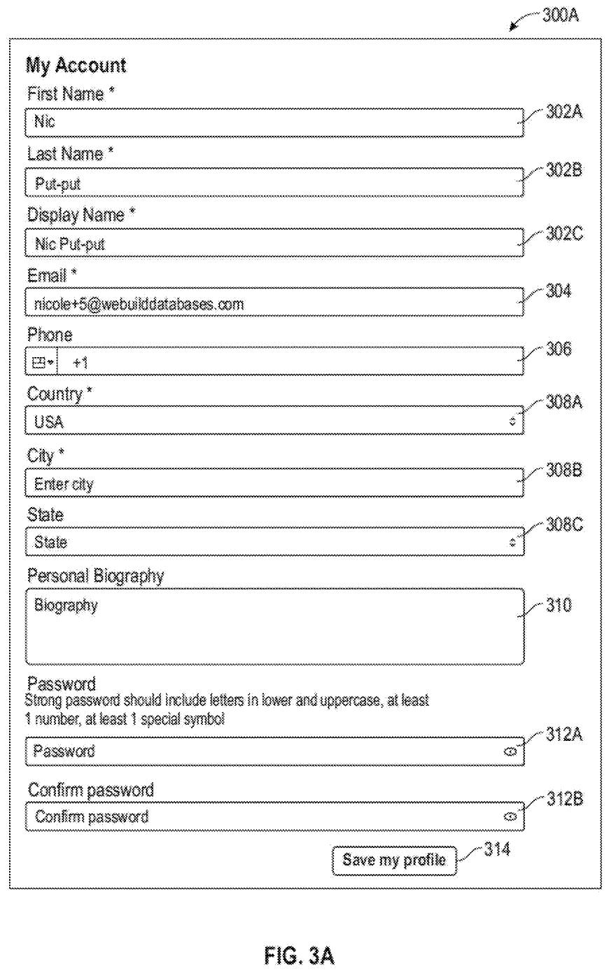

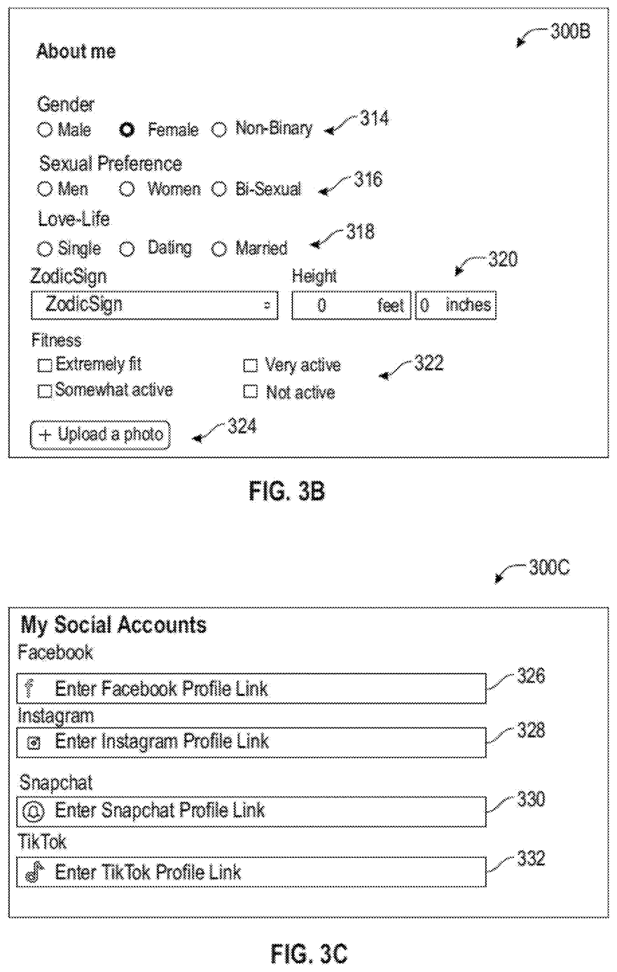

FIG. 3A illustrates a screen view of an account screen 300A for a platform or service in accordance with an embodiment of the disclosed principles. A platform or service as disclosed herein may utilize an account screen 300A for users to create and/or manage their account. There may be multiple pages, windows, and/or modules that allow a user to create, control, and/or manage their account through various fillable fields and/or selectable engagement areas. For example, a first name 302A, a last name 302B, and/or a username 302C. In at least one example, the username 302C may be utilized as a user id or a portion of a user id. A user id separate from the username 302C may be created in some examples. The user's email address 304 may also be entered for receiving communications from the platform. A user's phone number 306, address information such as but not limited to country 308A, city 308B, and/or state 308C may be utilized for geographical analysis and/or processing of information. A user may desire to include short biography information 310 that allows for a description of information the user would like known about themselves.

The user also is prompted to create a unique password 312A, which typically may be a set of characters, numbers, or special characters, put in some ordered combination that is known only to a user, and the program, application or app, and/or website. In at least one example, there may be a minimum number of characters, or combination of characters, numbers, or special characters, as an example the user password 312A may have to include at least one of each categories of possible variables to be used. Of course, other types of password for securing the user's account with the platform may also be employed. Additionally, the user may be requested to repeat and/or confirm their selected password 312B. In other implementations, a program, application or app, and/or website in use with a platform or service as disclosed herein may have multiple information fields and/or buttons throughout the pages, windows, or modules, which may comprise a lesser or greater number than in the illustrated embodiment. Finally, a save button 314 may be provided to allow a user to save all of the fields of their profile.

FIG. 3B is a screen view illustration of a personal profile screen 300B for a platform or service in accordance with an embodiment of the disclosed principles. A platform or service as disclosed herein may utilize such a profile screen 300B for users to provide personal details that may be used to help match other users of a disclosed platform or method to the user based on personal characteristics provided in the user's profile page. There may be multiple pages, windows, and/or modules that allow a user to provide any number of personal details that may be used to match the user to other users based on those other users' desired personal characteristics. In the illustrated embodiment, a user may provide such personal details such as but not limited to gender 314, sexual preference 316, life status 318, zodiac sign 320, and fitness level 322. Additionally, a user may use an upload button 324 to upload a photo of themselves that may be seen by others employing the platform or service in accordance with the disclosed principles. Of course, a greater or lesser number of personal characteristics may be included in an exemplary profile screen 300B.

FIG. 3C is a screen view illustration of a social media account screen 300C for a platform or service in accordance with an embodiment of the disclosed principles. More specifically, a user may use such a social media account screen 300C to provide other users their handles for their various social media account so that other users may connect and otherwise contact the user. Exemplary social media handles may include but are not limited to the user's Facebook 326, Instagram 328, Snapchat 330, and/or TikTok 332 account, as illustrated. Of course, other social media account handles may also be provided depending on the embodiment of the disclosed platform or service.

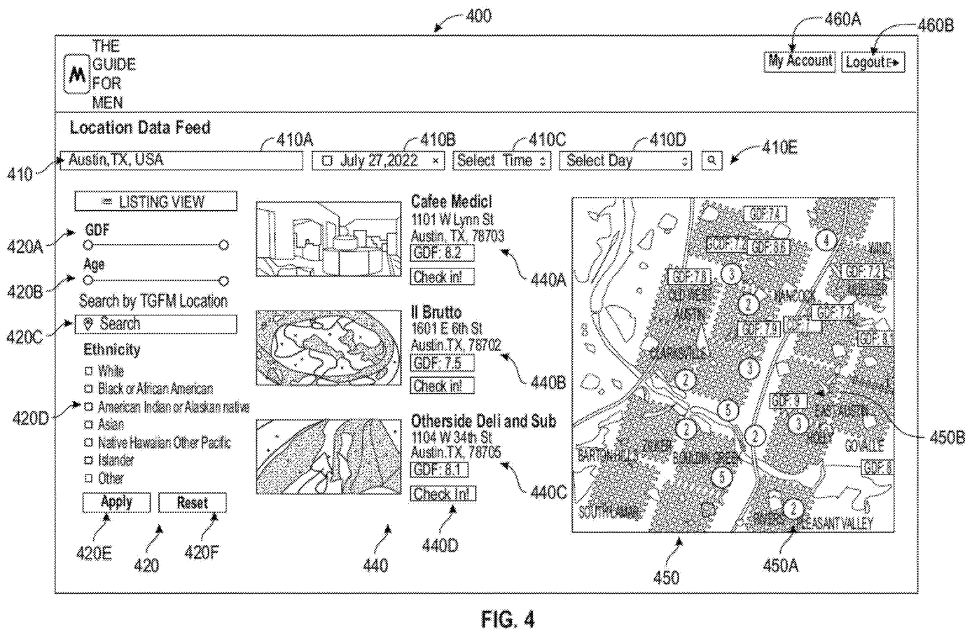

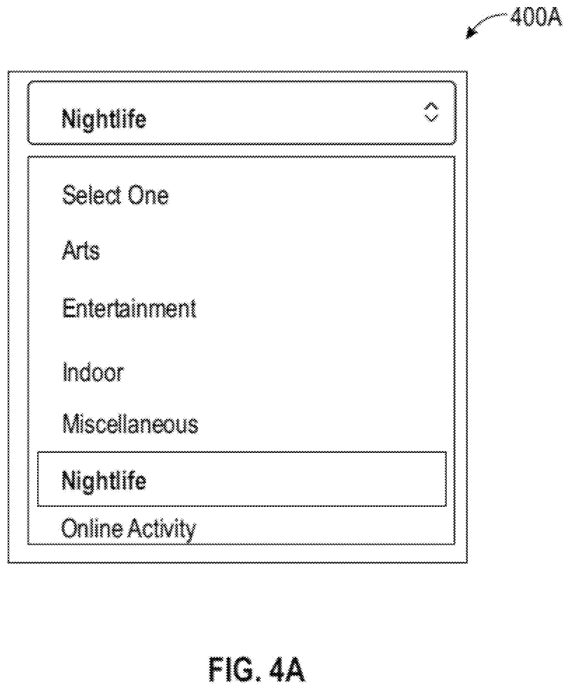

FIG. 4 is a screen view illustration of a user interface having a search screen 400 for a platform or service in accordance with an embodiment of the disclosed principles. In particular, such a search screen 400 may be used by a user to search for and find potential social prospects to meet. Specifically, the user enters search criteria of desired social prospects, and the platform or service as disclosed herein provides search results in the form of geographic locations where prospects matching the user's search criteria may be found or may have been in the past. In one example, in a dating or single mingling practical application of the disclosed principles, a user might conduct a search for social prospects based on search criteria 410 including, but not limited to, city 410A, date 410B, time 410C, and/or type of venue 410D where the social prospects would be met. Once these selections have been made, the user executes the search using a search button 410E. The results from these search criteria 410, as well as any other search criteria desired by an implementor of a platform or service as disclosed herein, may be further filtered using filters 420. The search results filters 420 may include one or more category, tag, etc. from a database(s) where the information is stored or derived from.

In a dating or single mingling practical application example, a user may filter by a rating factor 420A of potential prospects. In advantageous embodiments, the rating factor 410A may be a specialized rating factor pertaining to how likely or unlikely social prospects matching the searching user's desired characteristics will be or are at a specific location. This specialized rating factor may be comprised of both an objective and subjective component. In an exemplary embodiment, the objective component may be based on data that is gathered by the platform or service pertaining to the characteristics of social prospects that are located at a specific location. The subjective component may be based on data that is provided by one or more other users of the platform or service, and also pertains to the characteristics of social prospects that are located at a specific location. As a result, this rating factor changes based on the specific characteristics of social prospects a specific user is searching for based on the density of prospects at a specific location that match those specific characteristics. Moreover, a rating factor including both an objective and subjective component provides a more accurate measure of the specific characteristics of potential social prospects at a particular location. In some embodiments, the objective and subjective components of this unique rating factor may be provided separately.

In this illustrated embodiment, the rating factor is provided as “GDF”, which colloquially means “Goddamn Factor,” and thus can be seen as a measure of how impressive the potential social prospects at a certain location and having a given set of searched characteristics actually is. Of course, another name given to this unique rating factor. The GDF provides a searching user an additional component when searching for locations for meeting prospects that match the searching user's desired characteristics by allowing the filtering of the search results based on the level of GDF. More specifically, while a number of search result locations may be presented that have prospects matching many of the user's desired characteristics, filtering results by a higher GDF narrows the search result locations to those locations having an increased density of prospects matching the user's search criteria, or to those locations having prospects matching a greater number of the user's search criteria. Moreover, that filtering is a sliding scale based on a higher or lower GDP as selected by the searching user. Additional details regarding this rating factor, or GDF, are provided below.

Other filters may also be provided, including those based on more objective or empirical factors. These may include an age parameter 420B, which may be provided as a scale or range of ages for potential prospects. The ability to filter potential social prospects is important not just in a dating application of the disclosed principles, but also in other areas involving meeting social prospects. For example, if a platform or service as disclosed herein is used to search for play friends for children, filtering search results by age is certainly crucial. Another filter for the search results may include a “search within results” filter 420C, which may allow a user to further filter search results using a criteria such as limiting results to within a specific geographic location or distance. Yet another filter could include filtering the potential social prospects by ethnicity 420D or perhaps race. Of course, other filters may be included to narrow down search results, and a user interface in accordance with the disclosed principles may include any number of advantageous filters that assist users in narrowing down their searches to potential social prospects that more closely fall within the user's desired results. Once a user selects the desired filtering criteria, he may apply those filters to the search result by selecting an “Apply” button 420E. Alternatively, if the user desires to try different filters on his search results, the user may select a “Reset” button 420F, which resets the filters in order to start over again.

The filtered results generate a visual display of search results 440 in the user interface of a platform or service as disclosed herein. In this illustrated embodiment, there are a first result 440A, a second result 440B, and a third result 440C, and each of these results is location where social prospects meeting the user's search criteria may be located. Such determination may be made on a likelihood that matching social prospects will be at the displayed locations based on documented past experiences. As such, the disclosed principles may provide a prediction that matching social prospects are likely to be at the same location again. Alternatively, a disclosed platform or service may provide results indicating that matching social prospects are actually currently at the displayed locations. The manners in which each of these techniques generate search results are described in detail below.

As shown in FIG. 4, exemplary displayed location results 440 provide specific establishments where matching social prospects may be found. In addition to providing a list of establishments, specific information related to the user's search criteria and how it relates to the listed establishments may also be displayed. For example, in this illustrated embodiment the “GDF” for each particular search result is provided by each's listing. This GDF for each results is derived by providing an average or a mean of the GDF scores that have been generated for each particular location. As mentioned above, the GDF for any particular place is a combination of collection objective data and received subjective feedback, and pertains to the density of social prospects matching a particular set of searched characteristics at that particular place. Also provided with each of the search results is a Check In button 440D. This button may be used by the user to notify the platform or service that they are actually present at the particular location. By “checking in,” the platform or service may permit the user to not only confirm their location at the selected establishment, but also to provide feedback regarding the accuracy of the search results provided by the platform or service. Additional details of such a feedback option are provided below.

In addition to the illustrated list view of search results 440, filtered search results may also be provided on a map 450 generated and displayed, and having map highlights 450A, 450B. The map highlights 450A, 450B illustrate the multiple establishments or venues matching a user's search criteria and within a predetermined proximity. In addition to providing a visual indicator of each matching venue's location, such a view also allows a user to see the proximity of matching venues from one another, and thus the user can move between multiple venues if the desired social prospects are not available at a single venue when visited.

An exemplary user interface for use with a platform or service as disclosed herein may also have any number of additional buttons that allow users to interact or engage with the platform or service. For example, a My Account button 460A may be used by a user to access his account information to modify, edit, and/or create additional information regarding his account. A Logout button 460B may be used to allow a user to log out of their account with the platform or service, which thereafter the button 460B may become a Login button usable to log back into their account.

FIG. 4A is a screen view illustration of an additional search criterion 400A that may be included with a search screen 400 such as the screen of FIG. 4. Specifically, the additional search criterion 400A may be to search for a particular location type. For example, a dropdown menu for selecting an establishment type may provide multiple options from which the searching user may select. The user may then scroll through the available options of establishment type, and once the desired establishment type is found the user may simply click on the selected type to add to his search. In some embodiments, multiple selections from the dropdown menu may be made, thereby increasing the number of establishments displayed in the search results of FIG. 4. Although in the illustrated embodiment the selection options are Arts, Entertainment, Indoor, Miscellaneous, Nightlife, Online Activity, additional or other types of establishments may be included in such a dropdown menu.

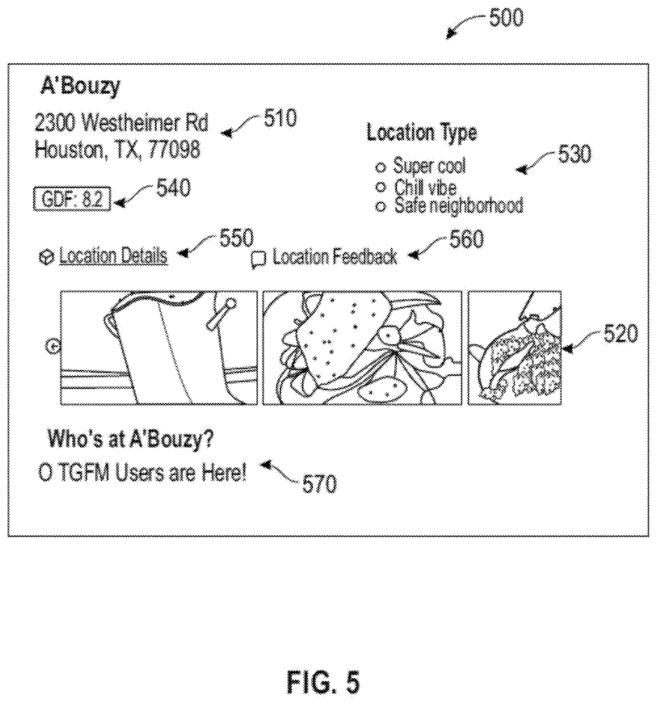

FIG. 5 is a screen view illustration of a search result detail screen 500, which may be among the results of a search conducted using the user interface of FIG. 4. A search result detail screen 500 not only provides the name and address 510 of the location, but also may present specific details regarding the location that can allow a user to decide whether to visit the location in search of desired social prospects. Among the details may be a gallery of images 520 taken at the location, which may provide a look at the décor, the food, the drinks, and the atmosphere of the location. Commentary 530 regarding the “type” of location may also be provided. The rating factor 410A discussed above may also be provided, which may also be selectable by the user in order to learn more details on how the rating factor 410A was derived. For example, if the rating factor 410A is a GDF or similar rating factor, selecting the button 410A may provide the user details on the individual rating scores provided by the ranking users or other persons. There may also be a link 550 to obtain additional location details, such as directions thereto, features and/or services provided by the venue, the venue's location, the venue's website, and other contact information for the venue. Another link 560 may also be provided for obtaining feedback on the specific location that may have been provided by patrons of the location to allow a user to see what others have said about the venue. Finally, the details page may also include information 570 regarding certain persons or groups of person currently visiting the location, including other users of the disclosed platform or service.

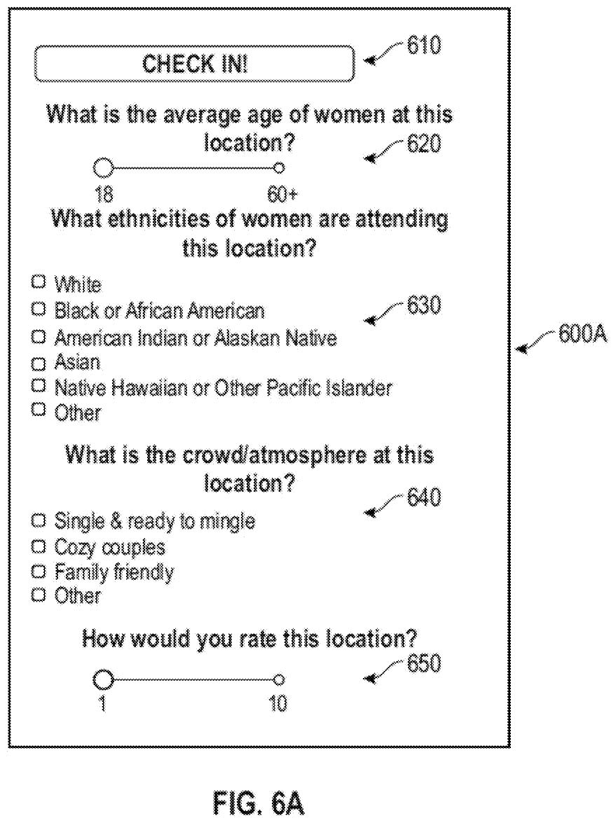

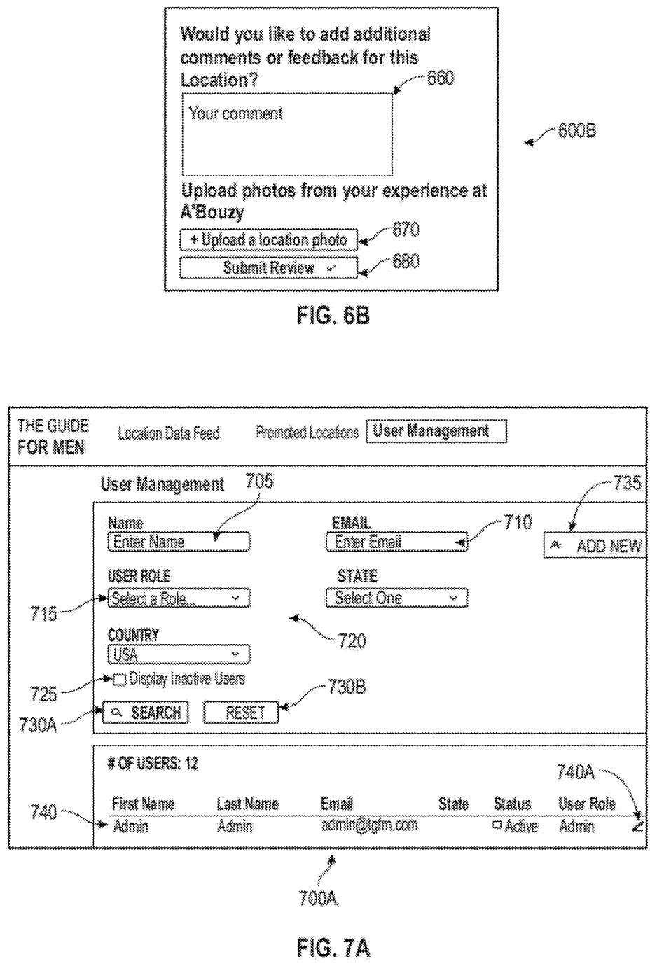

FIG. 6A is a screen view illustration of a Check In feedback screen 600A that may be employed by a user of a platform or service in accordance with an embodiment of the disclosed principles. The Check In screen 600A may be provided via a mobile application executing on a user's mobile computing device, or could be provided via a webpage or website accessible by a user via their computing device's browser software. As discussed above, a user can “check in” at a particular location in order to inform the platform or service that he is present at the location, as well as to potentially provide his feedback about the location. Such feedback can then be used to improve the accuracy of the search results provided to future users. In some embodiments, GPS confirmation, for example, via the user's phone, or other geolocation services and equipment, may be employed to ensure that a user is actually at a particular venue when checking in.

Looking at this illustrated embodiment, a Check In button 610 is provided for use by the user when he is ready to check in. However, additional information may be provided by the user before selecting the Check In button 610. For example, the user may provide information regarding the age of women or other social prospects they see at the location via an age range selector 620. Also, the various ethnicities of social prospects at the location may be selected from a list of ethnicity options 630. Moreover, the user can provide information about the crowd and/or atmosphere from a list of options 640. The user may also provide their overall personal ranking of the venue such as by using a 1-10 ranking scale 650. Of course, other types of sliders, lists and scales may also be employed for these illustrated Check In feedback options. When the user has finished making his various selections on the Check In screen 600A he may then select the Check In button 610 to complete the check in process.

By checking in and providing both subjective and objective information about a specific location, or social prospects at a specific location, a platform or service as disclosed herein can provide more accurate search results for other users employing the platform or service to search for social prospect they desire to meet. In some embodiments, the user checking in has not previously used the platform or service to search for social prospects, but instead is a prior user that elects to provide feedback information or perhaps is a provider of feedback sponsored by the platform or service. In embodiments where the user has previously employed the platform or service to search for venues having desired social prospects, the platform or service compiles information from the user's prior search(es) and the information provided by the user via the check in process to further hone the accuracy of future search results.

FIG. 6B illustrates a screen view of an additional Check In screen 600B. This additional screen may be provided along with the Check In screen 600A discuss with respect to FIG. 6A or may be a screen provided to a user when they are ready to leave the particular venue or has already left the venue. Among the additional information the user may provide via this additional screen 600B is a text box 660 where a user can provide a review of the location or other additional feedback via a narrative. Additionally, an Upload Photo button 670 may also be provided where a user can upload to the disclosed platform or service any photos the user may have taken at the location. Once the user has completed the additional information, he may submit the information via a Submit Review button 680.

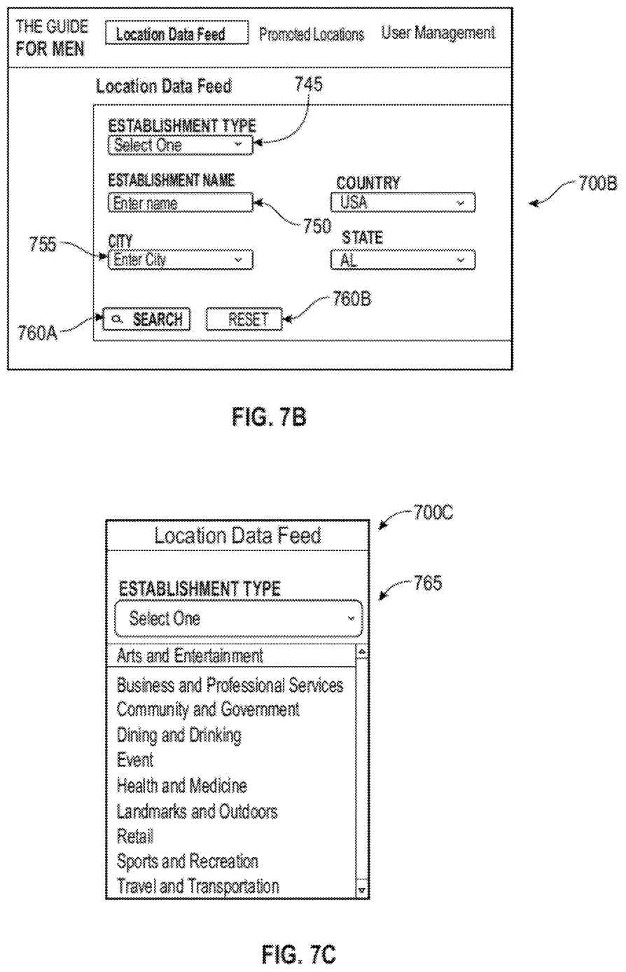

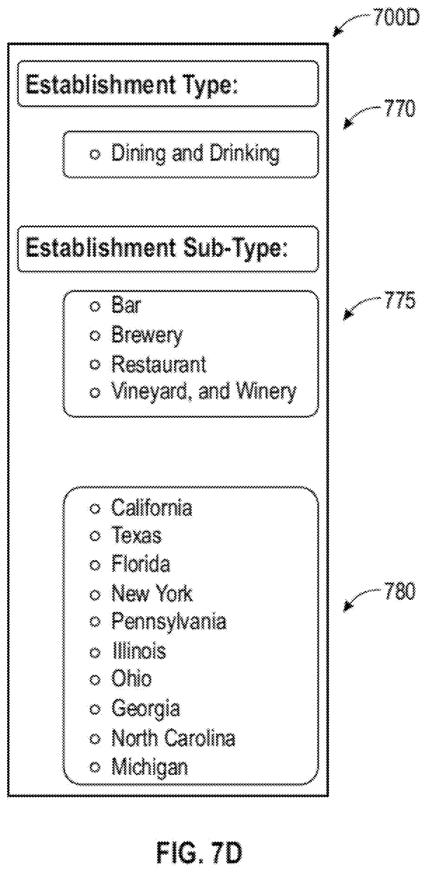

FIG. 7A is a screen view illustration of a User Management screen 700A accessible by an administrator of a platform or service in accordance with an embodiment of the disclosed principles. An exemplary User Management screen 700A may have multiple sections, each with one or more fields to enter data. Through such an exemplary User Management screen 700A, an administrator can search for users or add new users. Additionally, administrators may also search for users by user “role”, such as Admin, Staff, User, etc. Of course, other types of roles in relation to a platform or service as disclosed herein may also be included in a User Management screen 700A.

The User Management screen 700A can include a name field 705 that allows for a new user's or a current user's name to be added, edited, deleted, or simply searched. An email field 710 allows for a user email to be added, edited, deleted, or searched. A user role field 715 allows a user's role within an organization (company, venue, or other group) to be added, edited, deleted, or searched as well. Moreover, various address fields 720 allows for a user's address/location to be added, edited, deleted, or searched. An option 725 to only display current users or display even inactive users may also be provided. A Search button 730A allows for the displayed information of a particular user to be searched, while a Reset button 730B can be used to clear the search fields in order to begin entering information for a new user search. An Add New User button 735 allows for the fields provided on the User Management screen 700A to be cleared and new information to be added for adding a new user to the platform or service. A displayed list 740 of search results of users matching the search criteria discussed above may be displayed, from which an administrator may select a particular user. An edit button 740A may also be used by an administrator to edit information in the list of users.

FIG. 7B is a screen view illustration of a Location Data Feed screen 700B accessible by an administrator or user of a platform or service in accordance with an embodiment of the disclosed principles. An exemplary Location Data Feed screen 700B may have multiple sections, each with one or more fields to enter data. Through such an exemplary screen 700B, an administrator or user can search for establishments that are affiliated with a disclosed platform or service. In some embodiments, the Location Data Feed screen 700B may simply be used by an administrator or even a user to simply search for establishments in a given geographic location. Alternatively, in some embodiments, an administrator may use a Location Data Feed screen 700B to add new establishments to a disclosed platform or service as affiliates of the platform or service.

The Location Data Feed screen 700B can include any of a number of information fields, such as an establishment type 745, which could include a dropdown menu presenting multiple options from which to select a type, an establishment name 750, and location information 755 about the establishment. A Search button 760A allows for the displayed information of a potential establishment to be searched, while a Reset button 760B can be used to clear the search fields in order to begin entering information for a new establishment.

FIG. 7C is a screen view illustration of a close up view 700C of a dropdown menu for selecting an establishment type from the Location Data Feed screen of FIG. 7B. Once a user or an administrator selects the dropdown icon or caret, a dropdown menu 765 is presented. The user or administrator may then scroll through the available options of establishment type. Once the correct or desired establishment type is found, the user or administrator may simply click on the selected type. In some embodiments where the Location Data Feed screen is used to search for multiple establishments, multiple selections from the dropdown menu may be made, thereby increasing the number of establishments displayed in the search results. Although in the illustrated embodiment the selection options are Arts and Entertainment, Business and Professional Services, Community and Government, Dining and Drinking, Event, Health and Medicine, Landmarks and Outdoors, Retail, Sports and Recreation, Travel and Transportation, additional or other types of establishments may of course be included in such a dropdown menu.

FIG. 7D is a screen view illustration of an Establishment Sub-Type selection screen 700D. In this illustrated embodiment, once a user has selected an establishment type 770 from, for example, a dropdown menu like the one illustrated in FIG. 7C, establishment “sub-types” may then be provided to the user so as to provide another level of detail for the desired search.

In this example, the selected establishment type 770 is a Dining and Drinking establishment, which then presents a list of possible establishment sub-types 775 for the selected type of establishment. Such sub-types may be presented in any of a number of manners, such as an additional dropdown menu. Although the presented establishment sub-types are Bar, Brewery, Restaurant, and Vineyard and Winery, additional or other types of establishment sub-types may of course be included. Additionally, the establishment search may also include further filtering based on geographic location 780. For example, as illustrated, the presented geographic location filter options may be based on U.S. state; however, other options for geographically filtering establishment search results may also be provided. Such searching by geographic location can allow users to look for locations not only near them, but also to look ahead for trips to particular states and/or locations.

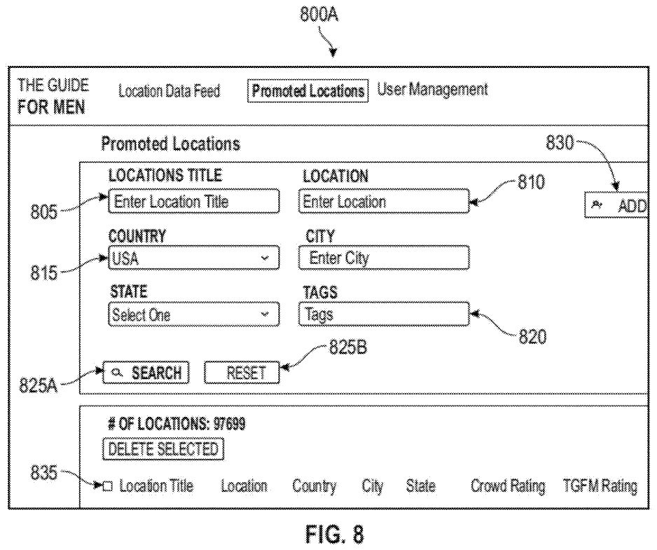

FIG. 8A is a screen view illustration of a Promoted Locations screen 800A accessible by a user of a platform or service in accordance with an embodiment of the disclosed principles. Promoted Locations screen 800A may be employed by a user or administrator to search for establishments that are previously affiliated with a platform or service as disclosed herein, or to add such an affiliated establishment.

An exemplary Promoted Locations screen 800A may include multiple sections, each with one or more fields to enter data. Through such an exemplary screen 800A, an administrator or user can search for establishments that are being promoted by a disclosed platform or service. In some embodiments, the Promoted Locations screen 800A may be used by an administrator or a user to search for promoted establishments in a given geographic location. Alternatively, in some embodiments, an administrator may use a Promoted Locations screen 800A to add new establishments to a disclosed platform or service as locations being promoted by the platform or service.

The Promoted Locations screen 800A can include any of a number of information fields, such as a promoted location's title 805, which could include a dropdown menu presenting multiple options from which to select a type of location, a promoted location's geographic location 810, and location information 815 about the promoted location(s). Additionally, a field 820 for entering a “tag” associated with promoted locations may also be provided. A Search button 825A allows for the displayed information of a potential promoted location to be searched, while a Reset button 825B can be used to clear the search fields in order to begin entering information for a new promoted location.

An Add New promoted location button 830 allows for the fields provided on the Promoted Locations screen 800A to be cleared and new information to be added for adding a new promoted location to the platform or service. A displayed list 835 of search results of promoted locations matching the search criteria discussed above may be displayed, from which a user or administrator may select a particular promoted locations. Additional information regarding the presented promoted locations may also be displayed in the list 835, such as a Crowd Rating or a rating of the location in general provided by the disclosed platform or service (illustrated as a “TGFM Rating”). Of course, other or additional information regarding the presented promoted locations may also be provided. Further, a Delete button 840 may also be used by an administrator to delete promoted locations, for example, if they are no longer being promoted by the platform or service.

### Feedback and Informational Databases

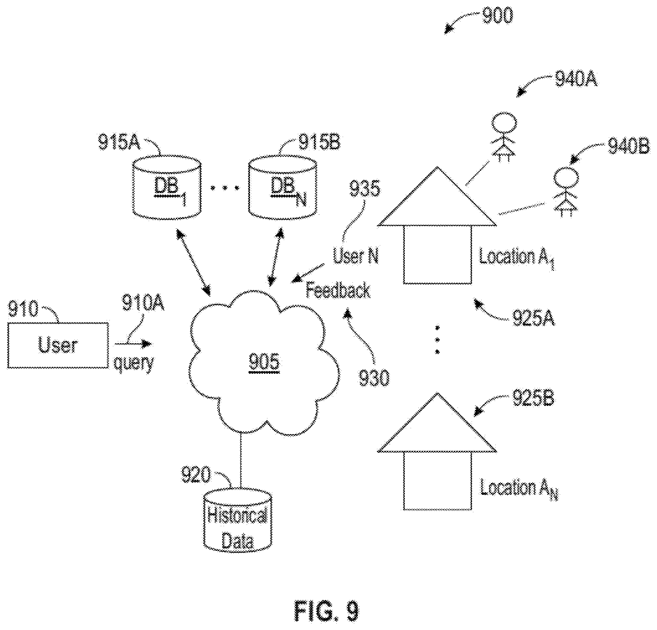

FIG. 9 illustrates a block diagram of a social networking system 900 incorporating a platform or system in accordance with an embodiment of the disclosed principles. The social networking system 900 can rely on users (e.g., individuals) that both use the system or operate businesses or other groups or events that engage or interact with the social networking system 900. The social networking system 900 can utilize a network 905, such as a computer network like the internet, that allows for user devices, processors, computing devices, databases, and other computer equipment to be interconnected. For example, a user 910 can access a platform or hosted service in accordance with the disclosed principles via the network 905.

A platform or service as disclosed herein can access one or more databases 915A, 915B (collectively 915), which would store and/or categorize information such as data, images, video, audio, and other types of information usable by a disclosed platform or system as disclosed herein. Additionally, the user 910 can query 910A the platform or service using their computing device in a manner that causes one or more processors or computing devices associated with the platform or service to access the at least one database 915 in response to the query 910A. In addition to the informational databases 915, an exemplary system 900 may also include one or more historical databases 920, discuss in further detail below.

As discussed in detail above, the user's query 910A of the system 900 may comprise a search for one or more locations that meet the user's desired and selected search criteria. In one exemplary embodiment, the user may be searching for bars or nightclubs, within a selected geographic region, and which are anticipated to have patrons meeting the user's selected gender, age, ethnicity, attractiveness factor (e.g., the “GDF” component introduced above), and other characteristics of prospects the user desired to meet in person. Various locations 925A, 925B, which could be any number of locations (collectively 925), are discoverable via the social networking system 900 using searches by a querying user 910 performed through a platform or service as disclosed herein.

While providing search results comprising locations, the social networking system 900 can employ feedback 930 to assist with the providing of search results to querying users 910, as described above. In particular, feedback 930 may be used within the system 900 to provide the platform or service information regarding both the demographic and personal characteristics of the social “prospects” or “targets” that users of the disclosed principles desired to meet, but also information regarding the type, ambience, features, etc. of the locations that are comprised within the search results of users. For example, feedback 930 may be provided by other users 935 acting as reviewers at certain locations 925 searchable by the system 900 in order to help confirm that the search results provided to a specific user are accurate. In such embodiments, a user/reviewer may provide real-time information into the system 900 via a platform or service as disclosed herein, such as via an application running on the user/reviewer's mobile computing device. Such user/reviewers may be specially selected and designated as authorized reviewers by the platform or service, or such reviewers may simply be random and voluntary users. In some embodiments, such reviewers may also include the prospects or targets (940A, 940B) querying users are hoping to meet using the disclosed principles. In such embodiments, these reviewers/targets (collectively 940) can confirm that they are at a location 925 and that they possess certain characteristics that are searchable by users of the platform or service. In some embodiments, geolocation data can be used in combination with such reviewers/targets to not only ensure they are at the location that claim to be or are checking in from, but also to ensure they possess some or all of the characteristics they are alleged to have and have been searched for by a user. In some embodiments, the provider(s) of feedback to the platform or service may be provided by an agent or agents affiliated with the one or more of the locations that are searchable by querying users of the platform or service. As before, this location feedback can be provided to a disclosed platform of service to assist in providing accurate search results to querying users, and may include information such as the personal characteristics of the people at the reporting agent's location, as well as confirming the type of location, ambience (and vibe/feel) of the location, features of the location, crowd size currently at the location, and other information usable by users to search for potential targets.

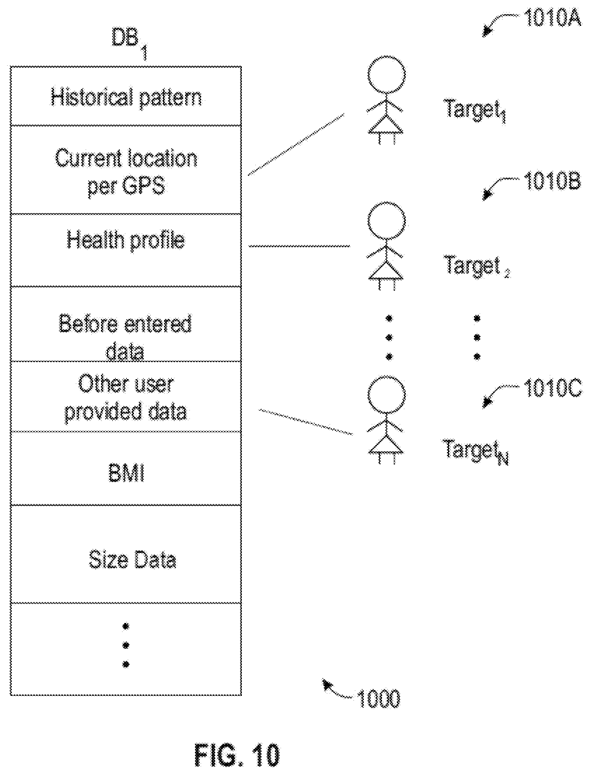

FIG. 10 illustrates a block diagram of a social networking system database 1000 for use with a platform or service in accordance with an embodiment of the disclosed principles. Specifically, in this embodiment, the system database is a personal information database 1000, which stores data regarding personal information of one or more potential user prospects or targets (1010A, 1010B, 1010C; collectively 1010). In some embodiments, the database 1000 is actually comprised of multiple databases, which in turn may be housed in distinct geographic locations.

Information stored in the one or more database 1000 can comprise any personal or otherwise usable information on potential targets users of the disclosed principles desire to meet in person, such as current location (e.g., via GPS data from their mobile device), historical pattern of locations visited, health profile, BMI, clothing size, etc. Of course, other types of personal information not illustrated may also be found in the one or more databases 1000, such as gender, race, ethnicity, education, occupation, whether they have children, marital status, religious affiliation, and other information. All such personal information may be found in various databases, such as mobile phone carrier records, education records, tax records, various medical records, medical facility records, social media accounts (including employing recognition technology to scan posted photos/images), purchase histories, and other unique information sources, and which may be accessible by a platform or service as disclosed herein via Terms of Service agreements that people typically agree to without review or objection, or even voluntary disclosure of some or all such personal information in exchange for something of value provided by the platform or service, or by any other party or entity.

Such personal information regarding potential prospects or targets of searching users may be employed by a disclosed platform or service to confirm information provided by user targets. More specifically, in embodiments where potential targets provide feedback to the platform or service by “checking in” at a particular location, such targets may provide not only feedback regarding the location they are at, but also feedback regarding their personal demographics and personal characteristics. However, such targets may provide false or misleading information about themselves, whether intentionally or not, and thus a target database or databases may be employed and queried to corroborate such provided personal information. Such corroboration is again used by a platform or service as disclosed herein to assist in providing as accurate of data as possible to searching users. In fact, even the target's current GPS information can be used to confirm that they are actually at the location about which they are providing feedback.

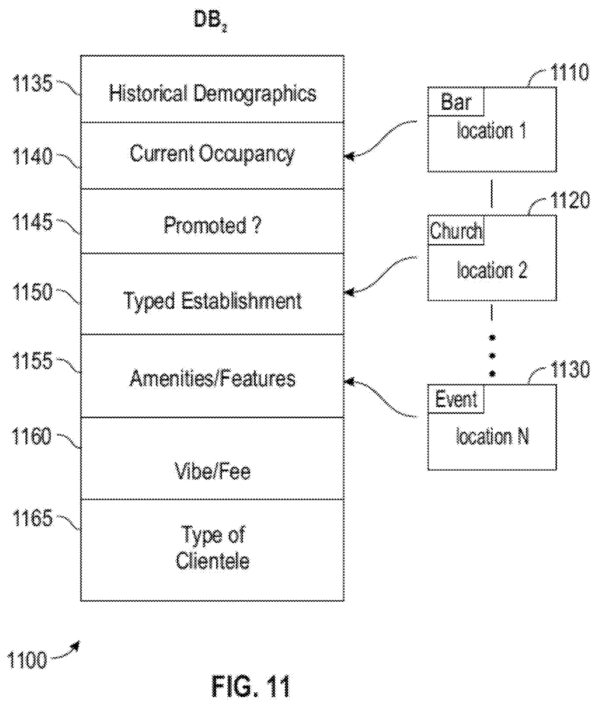

FIG. 11 illustrates a block diagram of a social networking location database 1100 for use with a platform or service in accordance with an embodiment of the disclosed principles. Specifically, in this embodiment, the location database, which stores data regarding information on various locations (1110, 1120 1130) that may be provided as search results to users using the platform or service. In some embodiments, the database 1100 is actually comprised of multiple databases, which in turn may be housed in distinct geographic locations.

In the illustrated embodiment, the location database(s) 1110 stores information related to locations such as a bar 1110, a church 1120, and event venue 1130, or any number of locations or location types. For example, for each location there can be data, images, video, audio, and other information categorized and/or tagged with information such as, but not limited to, historical demographics 1135, current occupancy at the location 1140, whether the location is a promoted location 1145 of the platform or system, the type of establishment 1150, amenities or features 1155 of the location, vibe/feel 1160 at the location, the type of clientele typically (or currently) 1165 at the location, and other information that might be relevant to a searching user. The information regarding locations may be obtained from any of a number of sources, such as governmental records, social media accounts and posts, company websites, or any database or source having information regarding a possible location. Indeed, information regarding a location may be provided by users and/or targets affiliated with a platform or service as disclosed herein. As before, such location information may also be corroborated with information obtained from users and/or targets affiliated with the disclosed platform or service via their own feedback or through databases of information associated with those users/targets.

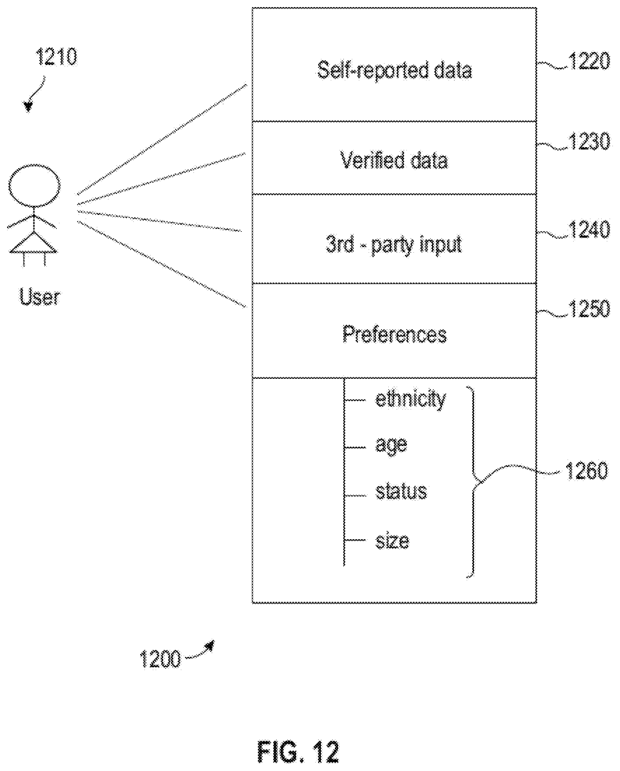

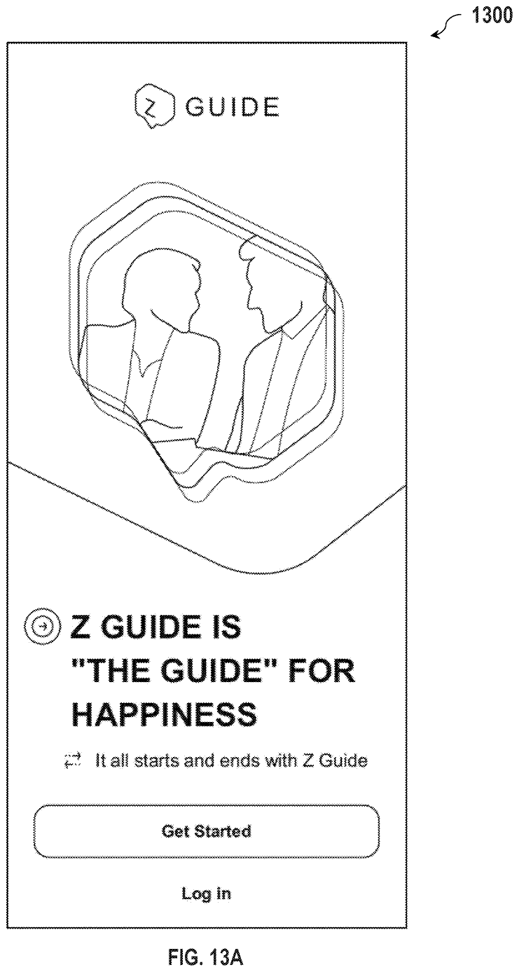

FIG. 12 illustrates a block diagram of a social networking user database system 1200 for use with a platform or service in accordance with an embodiment of the disclosed principles. Specifically, in this embodiment, the user database 1200, which stores data regarding information on users 1210 of a disclosed platform or service to search for social targets. In some embodiments, the user database 1200 is actually comprised of multiple databases, which in turn may be housed in distinct geographic locations.

Information stored in the one or more database 1200 can comprise any personal or otherwise usable information, such as the illustrated data self-reported by a user 1220, data about the user that has been verified 1230, data about the user provided by a 3^{rd} Party 1240, and search preferences 1250 of the user 1210. For example, in embodiments where the user 1210 employs the platform or service to search for social targets of a romantic nature, the stored user information may include the user's personal preferences for potential targets, such as ethnicity, age, marital status, body size, and/or other personal information 1260 of desirable targets.

Additional information about a user 1210 that may be stored in the database(s) 1200 may include information similar to that stored on targets, such as current location (e.g., via GPS data from their mobile device), historical pattern of locations visited, health profile, BMI, clothing size, gender, race, ethnicity, education, occupation, whether they have children, marital status, religious affiliation, and other information. As such, in embodiments where the user is a potential social target for a different user, such information is readily stored and may thus be corroborated.

As is the case with information regarding targets, stored information regarding a user 1210 obtained from or verified using (in cases where the user provided the information) various databases, such as mobile phone carrier records, education records, tax records, various medical records, medical facility records, social media accounts (including employing recognition technology to scan posted photos/images), purchase histories, and other unique information sources. Also as before, such information may be accessible by a platform or service as disclosed herein via Terms of Service or other similar agreements, as discussed above. Furthermore, corroborating information about a user 1210 may be provided by other users or targets at a location where the user 1210 is present as part of the feedback that can be provided to a disclosed platform or service.

### Monetization

Systems, platforms or services constructed and implemented in accordance with the disclosed principles provide a number of ways for monetization. Revenue may be generated through paid advertisements from establishments, such as restaurants, bars and clubs that may comprise the locations that form part of the search results for a searching user. Moreover, certain brands and retailers of various industries, such as alcohol, travel, ride sharing companies, etc., which may be displayed on any of the various screens presented to users and reviewers, may also provide paid advertisements for a disclosed platform or service.

Also, a premium (paid) version of the disclosed platform or service may be provided, which for a periodic fee can remove the presentation of some or all of the advertisements to users. Although removing the advertisements, etc., the periodic fees still provide a level of monetization for a platform or service as described herein. However, even with premium versions of a platform or service that remove the advertisements, monetization may still be possible via other means as our known and understood in the art.

### Premium Versions

A premium version may be configured to provide certain advantages over free or ad-supported versions of a disclosed platform or service. For example, a premium version may provide real-time results of social prospects a user is searching for. Specifically, a non-paid version of a platform or service as disclosed herein could be configured to only provide past/historical information on where searched-for social prospects have been found. Such a version still provides users valuable information regarding where their desired prospects have historically been found, as well as the days and times they have historically been at certain locations. However, in a premium version, users may be provided real-time information regarding where their desired social prospects may currently be found. Such real-time information provides an incredible advantage to paying users in meeting their desired prospects.

Also, in addition to simply charging such premium users a fee for the premium version of a platform or service, such premium features may be obtained by other means. For example, users may be rewarded for provided reviews, confirmations, or other types of feedback to the platform or service. Even high levels of use of a platform or service as disclosed herein can warrant rewarding a user simply due to the number of advertising impressions they've been served. In some embodiments, such rewards may be in the form of points or other accumulating units, where earning a predetermined level of points permits access to one or more premium features, or to a premium version of the platform or service overall, but perhaps for only a limited time. In some embodiments, instead of earning points, users may be permitted to retain access to a premium version only if they provide a minimum amount of feedback within a predetermined period, such as monthly. In advantageous embodiments, such rewards, points, or other means for earning access to a premium version of the platform or service may not be actually earned until the feedback or review information provided the user has been confirmed. In some embodiments, a combination of one or more of the above-discussed ways of obtaining premium access may also be implemented.

### Gamification

In some embodiments of a platform or service in accordance with the disclosed principles, “gamification” of the use of the platform or service may also be employed. Any of a variety of ways to “gamify” a platform or service can be used, for example, to encourage feedback, to reward users for premium status level, or to simply encourage more use of the platform or service in general. In one embodiment, such gamification may be similar to Pokeman Go® where users can earn points for using the platform or service to search for social prospects, for meeting people using the platform or service, or providing verifiable feedback for the platform or service. Additionally, in some embodiments, users may be encouraged/rewarded for posting their personal characteristics on the platform or service, for example, to see if other users would like to meet them. Promotions held by particular locations could similarly reward users for visiting their particular establishment as one of many possible search result locations for potentially meeting desired social prospects. Such rewards could be in the form of points, or perhaps other financial incentives like free drinks or other discounts at the location.

In some embodiments, a socialization component of a platform or service as disclosed herein could provide a gamification aspect. For example, instead of a single person looking to meet single social prospects, a user may instead be able to denote that he or she is one of a group of three or some other number in a group looking to meet desirable social prospects. A disclosed platform or service could then be used to provide locations where the same number of social prospects matching the searched for characteristics are located in a group. In such embodiments, the group of social prospects who use the platform or service can earn points or other rewards for alerting the platform or service about the size of their group. Moreover, in some embodiments, providing a searching user that is part of a group looking to meet the same or similarly numbered group of social prospects this capability may be a premium feature of a disclosed platform or service, as discussed above.

### Metaverse Applications

In addition to providing users of a platform or service as described herein unprecedented information on geographical locations to meet social prospects that match their desired characteristics, the disclosed principles are not limited to physical locations. In some embodiments, a platform or service as disclosed herein can provide users information on where and when to meet desired social prospects in virtual locations. More people in today's online age are meeting, or hoping to meet, others in a virtual setting rather than in person. A platform or service as disclosed herein can provide the same unique advantages and features discussed above for geographic locations in virtual environments. As such, a searching user could search for metaverse locations having potential social prospects that match their desired characteristics. Moreover, where searches for meeting social prospects in-person may focus on characteristics related to the physical world, such as physical appearance, income, marital status, whether they have any children, etc., characteristics for users searching for social prospects in the metaverse may instead focus on characteristics of a social prospect's avatar, a social prospect's status in a particular game or location in the metaverse, or other characteristics related more towards virtual environments rather than physical realms. Of course, a combination of such real-world and metaverse characteristics may also be employed by a searching user.

The present disclosure may include a computing device that can include any of an application specific integrated circuit (ASIC), a microprocessor, a microcontroller, a digital signal processor (DSP), a field-programmable gate array (FPGA), or equivalent discrete or integrated logic circuitry. In some examples, the system may include multiple components, such as any combination of one or more microprocessors, one or more microcontrollers, one or more DSPs, one or more ASICs, or one or more FPGAs. It would also be understood that multiples of the circuits, processors, or controllers could be used in combination or in tandem, or multithreading. Additionally, it would be understood that a browser or program could be implemented on a mobile device or mobile computing device, such as, a phone, a mobile phone, a cell phone, a tablet, a laptop, a mobile computer, a personal digital assistant (“PDA”), a processor, a microprocessor, a micro controller, or other devices or electronic systems capable of connecting to a user interface and/or display system. A mobile computing device or mobile device may also operate on or in the same manner as the computing device disclosed herein or be based on improvements thereof.

The components of the present disclosure may include any discrete and/or integrated electronic circuit components that implement analog and/or digital circuits capable of producing the functions attributed to the modules herein. For example, the components may include analog circuits, e.g., amplification circuits, filtering circuits, and/or other signal conditioning circuits. The components may also include digital circuits, e.g., combinational or sequential logic circuits, memory devices, etc. Furthermore, the modules may comprise memory that may include computer-readable instructions that, when executed cause the modules to perform various functions attributed to the modules herein.

Memory may include any volatile, non-volatile, magnetic, or electrical media, such as a random-access memory (RAM), dynamic random-access memory (DRAM), static random-access memory (SRAM), read-only memory (ROM), non-volatile RAM (NVRAM), electrically-erasable programmable ROM (EEPROM), flash memory, hard disks, or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, or any other number of possible drives or discs, that are executed by the internal logic of a computing device. It would be understood that the tangible non-transitory computer readable medium could also be considered a form of memory or storage media.

It should be noted that the term “button” has been utilized in an inclusive manner and may also be utilized to indicate an area that allows a user to engage or link to additional data, information, webpages, operations, actions, or otherwise engage with a computing or mobile computing device.

### Exemplary Mobile Device Application

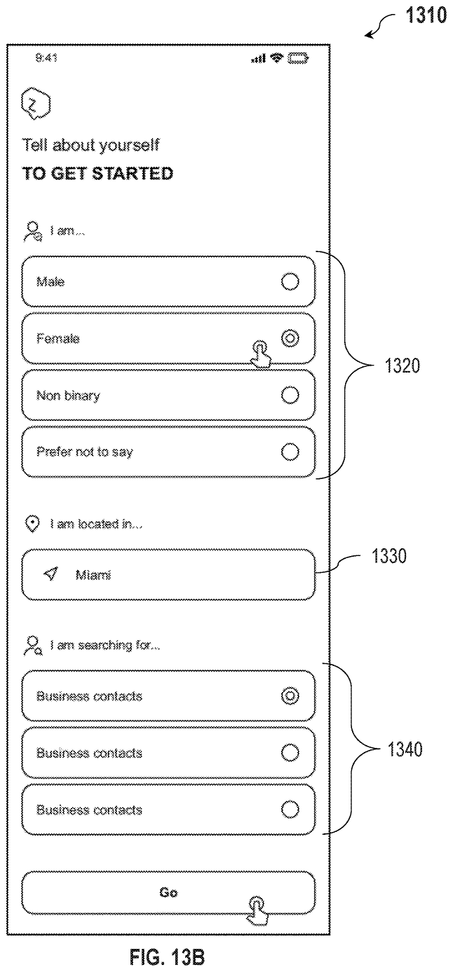

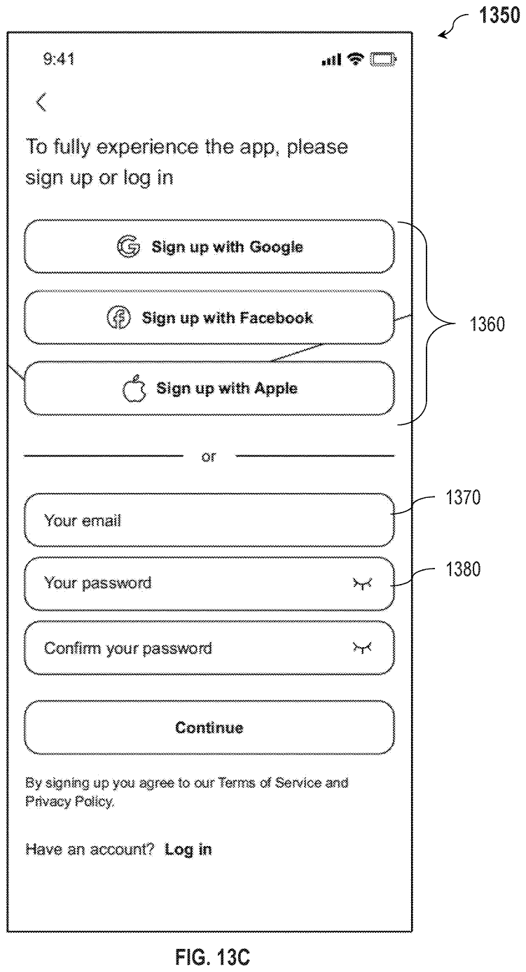

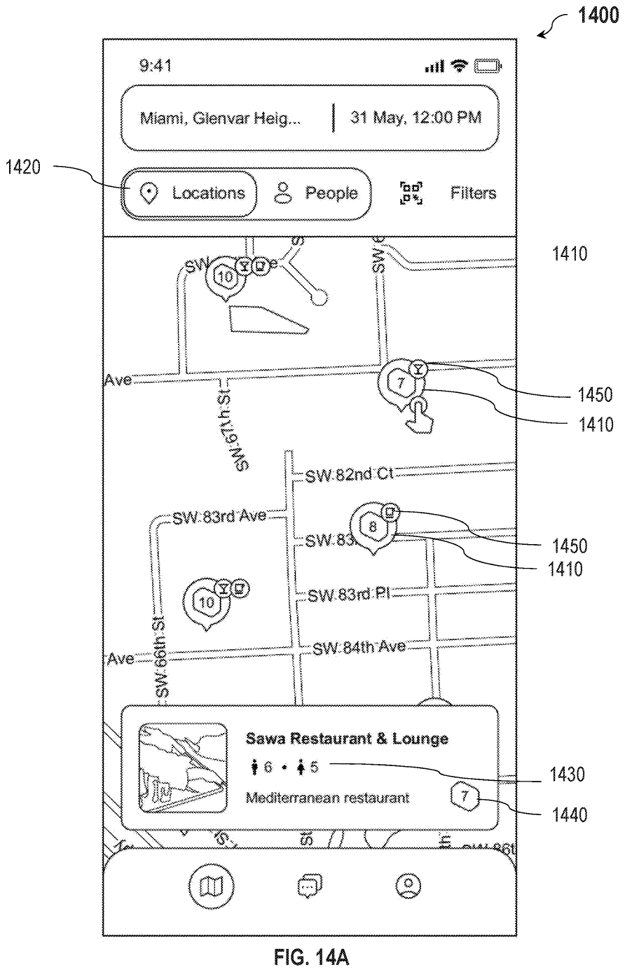

FIGS. 13A-13C illustrate exemplary screenshots of various account login and signup options from a mobile device application for use with a platform or service in accordance with the disclosed principles. FIG. 13A provides a screenshot 1300 of one embodiment of an introductory welcome screen for a user or potential user of the platform or service associated with the mobile application. On such a screen, the user would have the option to log in with their personal credentials if they already have an account with the platform or service, or to create such an account in the first instance.

FIG. 13B illustrates a screenshot 1310 of one embodiment of a page where a new user may input their personal information in order to create an account on the platform or service. In this embodiment, the user may provide their gender information 1320, their geographic location 1330, and their intended purpose 1340 for becoming a user of the platform or service. For example, as discussed in detail above, the user may wish to join in order to search for and find potential romantic prospects, potential new friends, and/or potential business prospects, all of which are social prospects as disclosed herein. A user may select one or more such options for using a platform or service as disclosed herein, and then tailor their future searches and matches of social prospects while using the platform or service.

FIG. 13C illustrates a screenshot 1350 of one embodiment of a page where a new user may provide their personal information in order to create an account on the platform or service by linking one or more previously existing accounts 1360 of the user. In this embodiment, the user may create their account by using their sign in credentials and information associated with their Google account, with their Facebook account, or with their Apple account. Of course, any preexisting account of the user may be used in this manner, such as an Instagram account, a Twitter account, a LinkedIn account, etc. Once a user has provided login credentials to the platform or service via the mobile application, the user may then provide their email address 1370 or other contact information, as well as a secure password 1380 for accessing their newly created account.

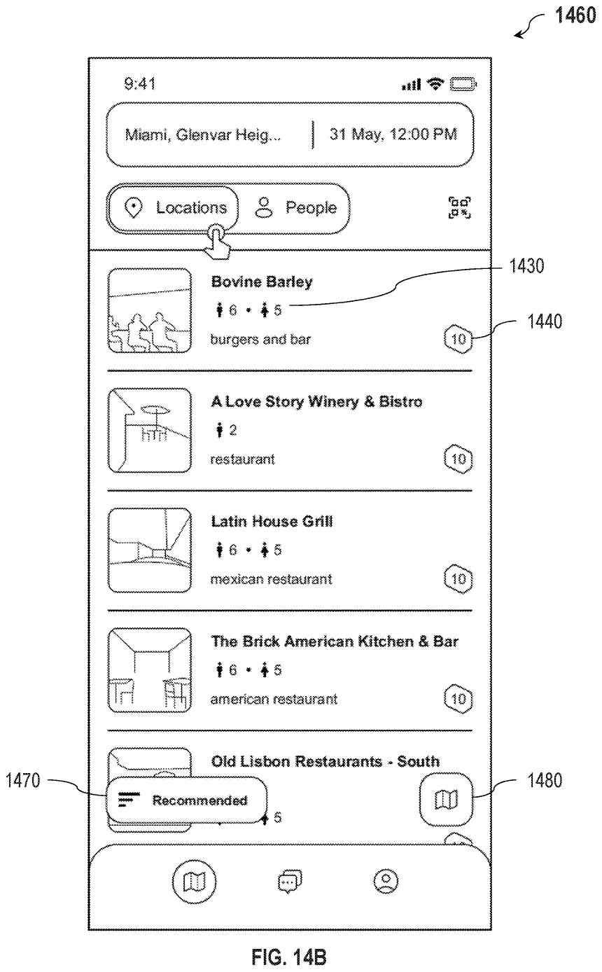

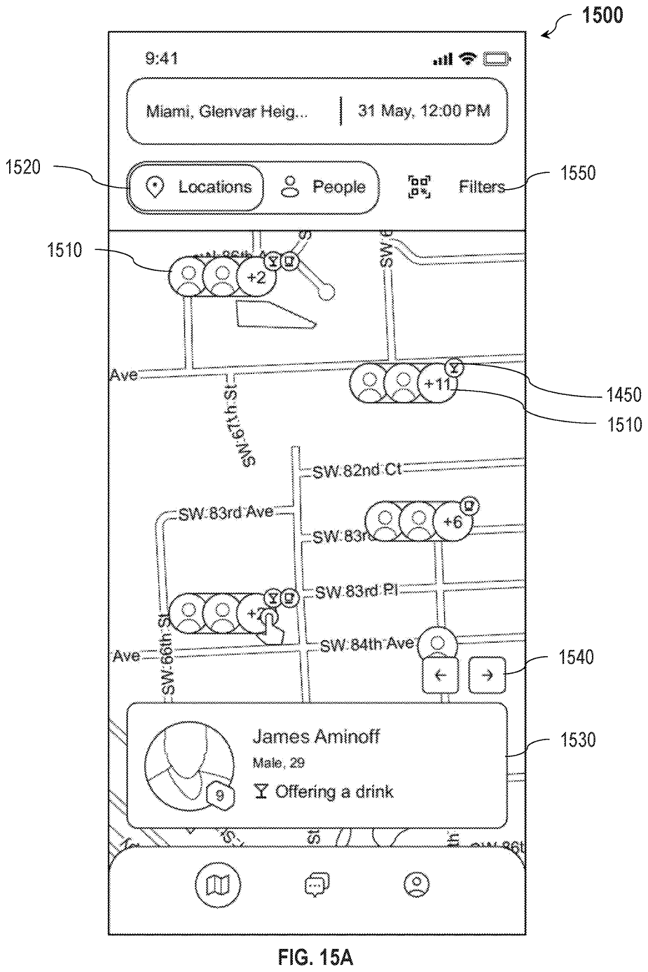

FIG. 14A illustrates an exemplary screenshot 1400 from a mobile application, for use with a platform or service in accordance with the disclosed principles, of an interactive map presenting establishments 1410 matching search criteria of a user of the mobile application. In particular, the “Locations” button is selected by the user so that icons representing the geographic location of the matching establishments 1410 are shown.

To find matching establishments, the user may enter search criteria of desired social prospects, and the platform or service as disclosed herein provides search results in the form of geographic locations 1410 where prospects matching the user's search criteria may be found or may have been in the past. Searches may be conducted in the manner discussed above, or artificial intelligence (AI) may be employed to develop a search on behalf of the user. AI implementations are discussed in further detail below.

As illustrated, locations/establishments 1410 matching the user's search criteria at not only illustrated using interactive icons, but such icons may include a rating factor, such as those discussed above, of the establishment in the manner discussed above as well. In this illustrated embodiment, the ratings are different for each establishment 1410, and may be developed in any of a number of different ways. For example, establishment ratings (which may colloquially be known as a “Z Score” or “Z Rating” or “Z Factor”, in addition to the exemplary labels mentioned above) may be a conglomeration of ratings provided by users of the platform or service. In other embodiments, the provided rating may be determined by the platform or service, and may also be determined at least in part by information provided or garnered from the establishments' 1410 interaction with the platform or service. In yet other embodiments, AI may be implemented to determine each establishment's rating by scraping information from any applicable source to provide an appropriate rating to each establishment 1410. In even further embodiments, establishment ratings may differ when displayed to each user of the platform or service, where each is determined with influence from each particular user's profile/personal information and/or their interaction with the platform or service. Of course, any technique for developing a rating for each establishment may be employed.

Additionally, each presented icon of each establishment comprising the search results may be interactive. For example, the user may click on a particular icon to view more details about that establishment, as illustrated at the bottom of the screen in FIG. 14A. Also as illustrated, the further details about the selected establishment may include the number of other users 1430 currently present at the establishment, and may even display the number of each gender of the users present. Moreover, the icon displaying the rating 1440 of the establishment may be interactive so as to display to the user more details about that rating, what comprises the rating, and perhaps even how the rating for that establishment was developed.

Also illustrated in relation to the rating icons for each establishment are additional icons 1450. These are shown as a martini glass or a coffee cup, although any shape or item may comprise these additional icons 1450. The meaning of these additional icons 1450 are “offers” presently being extended by other users (i.e., potential social prospects) at each particular establishment. In exemplary embodiments, the martini glass icon may be displayed at a particular establishment to indicate that another user currently has extended an “offer to buy a drink” to a social prospect of theirs. This may or may not be the original user viewing the screenshot of FIG. 14A, based on the criteria the user extending the drink offer. Similarly, the coffee cup icon may be displayed at a particular establishment to indicate that another user currently has extended an “offer to have a cup a coffee” to a social prospect of theirs. Again, this may or may not be the original user viewing the screenshot based on the criteria the user extending the offer. Moreover, the type of offer being extended is based on the goal of the user extending the offer. Thus, an “offer to buy a drink” could mean that the user has a romantic interest in meeting a social prospect, while an “offer to have a cup of coffee” could mean that the user would like to meet social prospects for business networking. Of course, any type of icon can be used to indicate these intentions of users currently located at the displayed establishments.

Moreover, additional icons 1450 may be displayed to indicate other intentions for meeting social prospects, such as meeting prospects for friendly reasons (e.g., participating in activity together, such as tennis or chess), meeting prospects that children for the purpose of finding playmates for the user's child or children, or for any reason that a user may want to meet another user socially. In yet other embodiments, a number may be included in such additional icons 1450 to indicate the number of each extended type of offer at each establishment, while in some embodiments, the additional icons 1450 may be clickable to find out such information. Doing so may cause another screen indicating such information to be displayed to the user.

Turning briefly to FIG. 14B, illustrated is a screenshot 1460 presenting a list view of the establishments displayed geographically on the map of FIG. 14A. Such a list view permits a user of the mobile application to quickly scroll through all of the establishments comprising the search results without having to click on the icon of each establishment displayed on the prior map view. The list of establishments may also be sortable using any of a number of criteria, such as alphabetical sorting or sorting based on the magnitude of the rating 1440 each establishment has. Other sorting criteria may include the number of potential social prospects 1430 at each location (even the number of a certain gender), the type of establishment (e.g., bar vs. restaurant vs. nightclub), AI providing a sorting of the list based on the user's search criteria, or any other desirable sorting criteria. Also, a “Recommended” button 1470 may be provided for such sorting based on a user's previously determined search criteria or their interactions with the platform or service when searching previously. Finally, a map view button 1480 may be provided so that the user may switch back to the map view of FIG. 14A, when desired.

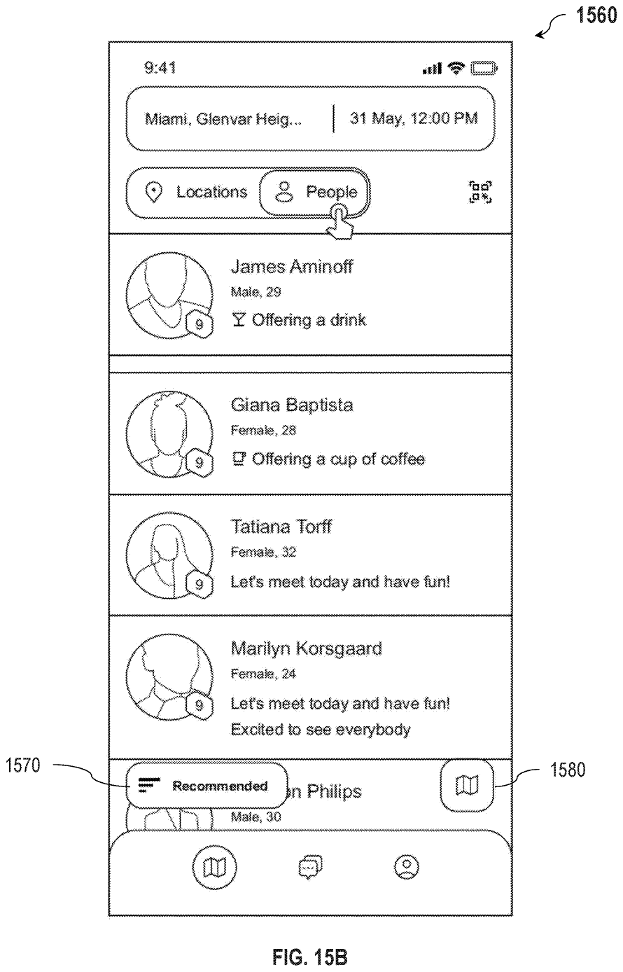

Looking now at FIG. 15A, illustrated is an exemplary screenshot 1500 from a mobile application, for use with a platform or service in accordance with the disclosed principles, of an interactive map presenting social prospects 1510 (e.g., other users) matching search criteria of a user of the mobile application. In particular, the “People” button 1520 is selected by the user so that icons representing the specific prospects at each geographic location of the matching establishments are shown. As illustrated, icons representing the prospects at each establishment, which in this example are profile pictures of the individual prospects 1510. Additionally, the number of potential social prospects 1510 may also be displayed as part of the icons, and in situations where the number of prospects 1510 at a particular establishment is too large to display all of their profile images, only the first few prospects' images may be displayed on the map. Moreover, the few that are displayed may be selected by the platform or service (via AI or other means) to be the prospects that most closely match the user's search criteria. In other embodiments, the few that are displayed are simply selected randomly.

Also illustrated on or proximate to the icons representing the prospects at each establishment are the additional icons 1450 discussed above. Specifically, these additional icons 1450 may comprise the aforementioned martini glass or coffee cup icons (or other possible icons having different meanings) discussed in detail above. Also illustrated in FIG. 15A at the bottom of the screenshot is a pop up 1530 of a particular prospect currently at one of the establishments. In this embodiment, the user has clicked one of the icons 1510 to display on the pop up 1530 having more information about the particular social prospect. Exemplary information that may be displayed in the pop up 1530 can include one or more profile images, the specific rating factor of the prospect, personal information about the prospect, and whether the prospect is one of the users who has “offered to buy a drink” or “offered to buy a cup of coffee”. Moreover, in some embodiments, the user may be able to click the pop up 1530 to access the entire profile of the prospect. Also as illustrated, navigation buttons 1540 may be provided so that the user may progress forward or backward through the prospects 1510 present at the various displayed establishments, where each prospect will appear in the pop up window 1530 as the user progresses through the present prospects 1510.

A “Filters” button 1550 may be provided so that the user may also filter the displayed icons and associated prospects 1510 based on any of a number of criteria selectable by the user. For example, the user may wish to filter the displayed results so that only a certain gender of prospects is displayed and/or perhaps only those prospects offering a drink or a cup of coffee. In some embodiments, the prospects may be filtered based on the rating factor of the present prospects. In yet other embodiments, AI may be used to filter the displayed prospects at each establishment such that only those likely to match the user's criteria will be displayed. In such embodiments, the choice to manually filter or filter using AI may be provided via clicking the Filters button, which in turn may display or pop up a filtering screen, which is interactive with the user.

Turning to FIG. 15B, illustrated is an exemplary screenshot 1560 from a mobile application of a list view for the social prospects matching search criteria of a user of the mobile application and illustrated in the map view of FIG. 15A. Such a list view permits a user of the mobile application to quickly scroll through all of the presented social prospects comprising the search results without having to click on the icon of each prospect displayed on the prior map view. The list of prospects may also be sortable using any of a number of criteria, such as alphabetical sorting or sorting based on the magnitude of the rating each prospect has. Other sorting criteria may include the gender or other personal characteristics of potential social prospects, AI providing a sorting of the list based on the user's search criteria or previous interaction with the platform or service, or any other desirable sorting criteria. Also, a “Recommended” button 1570 may be provided for such sorting based on a user's previously determined search criteria or their interactions with the platform or service when searching previously. Finally, a map view button 1580 may be provided so that the user may switch back to the

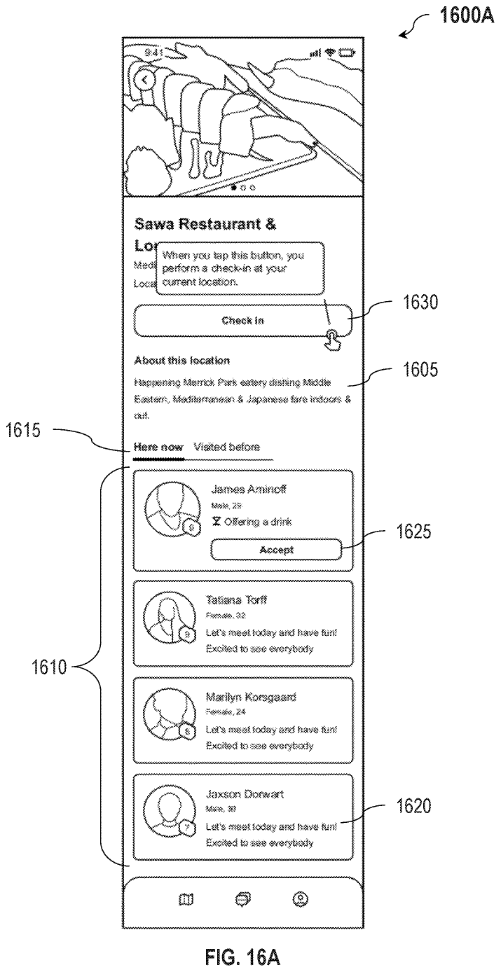

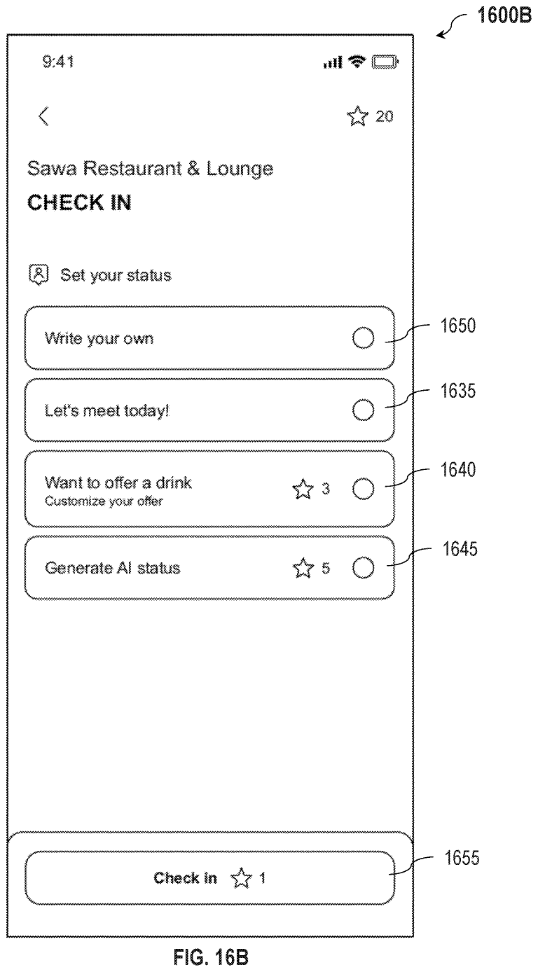

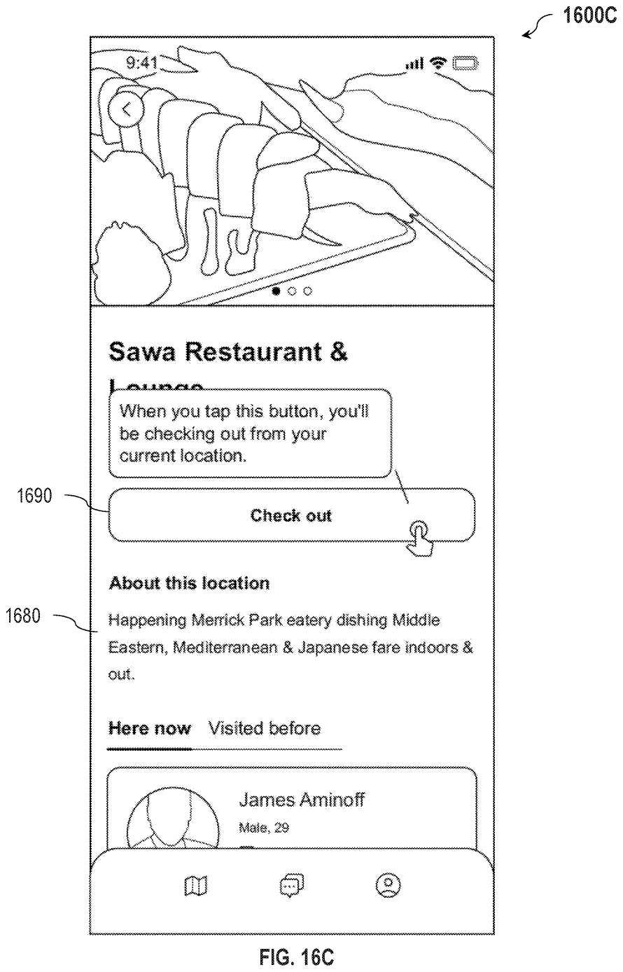

FIG. 16A illustrates an exemplary screenshot 1600A from a mobile application, for use with a platform or service in accordance with the disclosed principles, of details associated with a single establishment matching search criteria of a user of the mobile application and selected by the user. An exemplary screenshot 1600A may provide detailed information 1605 about the establishment. In some embodiments, the rating factor of the selected establishment may be presented to the user. As before, an icon (not illustrated) displaying this rating factor may be selected by the user to display details of how the rating factor for the establishment was determined.

Additionally, as illustrated, such a screenshot 1600A can provide the user a list 1610 of social prospects currently located at the same establishment. More specifically, a “Here now” tab 1615 may be selected by the user to present a list of the currently present social prospects. Such a list, as in the examples discussed above, may be organized, sorted, and filtered as desired by the user. Within the list 1610 of social prospects, additional details 1620 of each of the prospects displayed to the user may be provided. Such details may include, for example, the rating factor of each prospect, personal characteristics of each prospect, and whether or not the prospect has indicated a desire to meet other people while they are at the establishment. As before, the list 1610 may be clickable by the user to access the full profile of a selected prospect, if desired. Also, as illustrated, if a social prospect has indicated their desire to meet other people by “offering a drink” or “offering a cup of coffee”, or any other means of providing such an indication, a button 1625 may be provided to the user so that they can accept that prospect's invitation. In the illustrated example, a button 1625 marked “Accept” is provided so that the user can accept that prospect's offering of a drink to someone. In other embodiments, buttons or other means (not illustrated) may be provided to the user so that the user may select to “offer a drink” or “offer a cup of coffee” to one of the present prospects.

Also illustrated in this embodiment of the screenshot 1600A is a “Check in” button 1630, which may function as the Check In button(s) discuss in detail above. For example, a user can “check in” once they are at the geographical location of the particular establishment. As before, an exemplary mobile application may work with the location technology of the mobile device on which it is executing, such as GPS, to ensure that the user is actually at the geographic location of the establishment when they are checking in. By “checking in,” the platform or service may permit the user to not only confirm their location at the selected establishment, but also to provide feedback regarding the accuracy of the search results provided by the platform or service, as described above. Advantageously, once the user “checks in” at a location, other mobile applications executing on other users' devices, which are also in communication with a platform or services as disclosed herein, will be updated to indicate to those other users the presence of the checked in user at the establishment.

Looking briefly at FIG. 16B, illustrated is a screenshot 1600B of a “Check In” screen of the mobile application of FIG. 16A. On this screen 1600B, the user may provide their “status” while at the establish at which they are checking in. Exemplary statuses may include indicating to other users 1635 (which may be limited to only matching users found during a search for prospects as disclosed herein), indicating that the user is “offering a drink” 1640 to other (matching) users, or the user can elect to have an AI engine generate their status 1645 for them. Alternatively, the user may elect to write their own status 1650, for example, if any of the available options or the AI generated status is not acceptable to the user. Once the user has set their status, or perhaps elected not to set a status at all, the user can click the “Check In” button 1655 to complete the check in process at the establishment. Such status information may then be available to other users of the platform or service disclosed herein.

Returning to FIG. 16A, also illustrated in the screenshot 1600 is a “Visited before” tab 1670. This tab 1670 may be selected by the user to display a different list of social prospects, which are prospects that have visited the establishment in the past. As with the prior lists, this list of prospects may also be sorted or organized in any advantageous manner. Similarly, this list of prospects may again be interactive such that the user may select the display of a prospect in order to access that prospect's full profile. A platform or service as disclosed herein can determine that a prior user/prospect has previously visited an establishment in a number of different ways. For example, that prospect may have checked in at the establishment in the manner disclosed herein, and the date and time that the prospect checked in and was at the establishment in the past may also be presented to the user. Additionally or alternatively, the prior location of prospects at a particular establishment may be determined via location technology of the device on which a mobile application in accordance with the disclosed principles is executing. Information regarding these users that previously visited the establishment can include personal characteristics of the person, images of the person, whether the person offered or accepted any drinks or cups of coffee (or similar offers/acceptances), the rating factor attributed to that person, or any other useful information as disclosed herein.

FIG. 16C illustrates an exemplary screenshot 1600C from a mobile application of a “check out” feature associated with a single establishment matching search criteria of a user of the mobile application. As with the screenshot 1600A in FIG. 16A, this screenshot 1600C again illustrates a particular establishment selected by the user. As such, details 1680 about the establishment may again be provided to the user. This screen 1600C may be presented to the user after the user has checked in at the selected establishment. While remaining at the establishment, the user remains checked in. As such, this screen 1600C presents a “Check out” button 1690 that the user may select when they are leaving the establishment. As with the “Check in” button discussed above, when a user checks out from the establishment, his mobile application will provide his checked out status to the platform or service, which in turn provides that status to other mobile applications of other users. In some embodiments, the application can automatically check out a user when that user leaves the establishment. For example, location technology on the mobile device on which the application is executing can confirm that the user's geographic location no longer coincides with the establishment. Such embodiments are advantageous in situations when users forget to select the Check out button 1690 when they leave an establishment so that other users are not falsely informed that the user is located at the establishment after they have left.

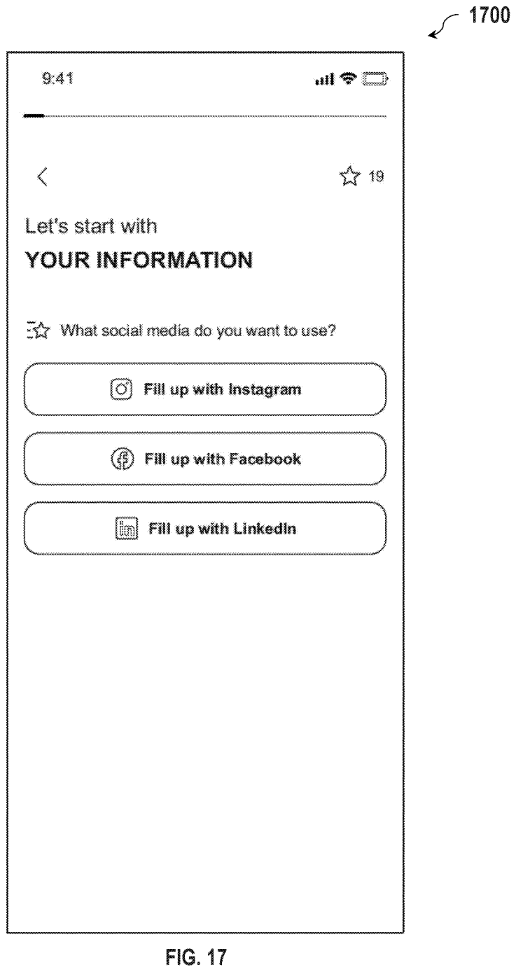

Referring now to FIG. 17, illustrated is an exemplary screenshot 1700 from a mobile application, for use with a platform or service in accordance with the disclosed principles, presenting a user of the mobile application an option to integrate with one or more social media profiles of the user. As with situations described above where a user may use one or more of their social media profiles to create an account with the platform or service, the user can elect to integrate one or more of their social media profiles with the platform or service via the mobile application to assist with providing information about the user to other users and assisting with determining search criteria that would be desirable to the user.

Once the user rated our social media profile with the platform or service, his mobile application or the platform or service can scrape data from the users integrated profile. This scraped data can not only be used to create the users account, but may be used to automatically determine certain search criteria associated with the user. For example, such search criteria may be determined based on interests and other information gathered from his integrated social media profile. In addition to traditional data scraping tools, AI may be employed to determine characteristics, interests, and other information personal to the user and which may be used to determine what characteristics potential social prospects should have that would be attractive to the user. For example, if a data scraping or AI tool can detect that the user has posted about certain types of pets or certain activities, then that information can be used to find potential matches for the user. Such determinations may be advantageous in situations where the user employs the disclosed platform or service for romantic goals; however, similar determinations may be used to determine other types of prospects that may be of interest to the user. For example, if the user's social media profile revealed he or she was in a particular business, then prospects having characteristics that may be advantageous for the user to meet for business purposes can also be determined.

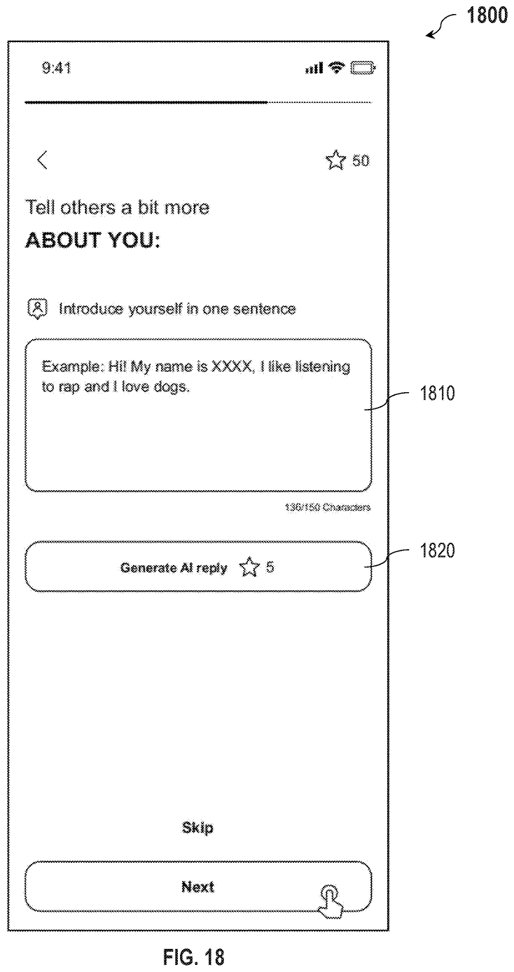

Looking now at FIG. 18, illustrated is an exemplary screenshot 1800 from a mobile application, for use with a platform or service in accordance with the disclosed principles, presenting a user of the mobile application an option to have an AI engine determine search criteria for social prospects on behalf of the user. As mentioned above, users of the mobile application may integrate one or more of their social media accounts with the platform or service to import information about the user into their account. Once doing so, the application may offer the user the opportunity to provide a description in a text box 1810 about themselves, including personal characteristics, interests, and perhaps details regarding what characteristics found in potential social prospects would interest them.

Alternatively, the mobile application may offer the user the opportunity, for example, via a button 1820, to have an AI engine create such a description about the user. If the AI option is selected by the user, the AI can evaluate the user's integrated social media account(s) to develop a description about the user's personality, interests, and the characteristics the user would likely like to see in potential social prospects they would meet through the disclosed platform or service. As discussed above, this may comprise the AI evaluating details about the user found in their integrated account(s), the user's posts and messaging, images the user posted, “liked” or commented on, what others have comments or “liked” about the user or his/her posts, and any other information the AI can garner regarding the user. The AI may then use that information to determine search criteria on behalf of the user that the AI “believes” will find good matches for the user. As mentioned above, the AI engine may also be useful in helping a user write or develop or adjust the detail of his/her profile to promote characteristics the AI determines may be attractive to other users on the platform or service, and thus help those potential social prospects seek out the user.

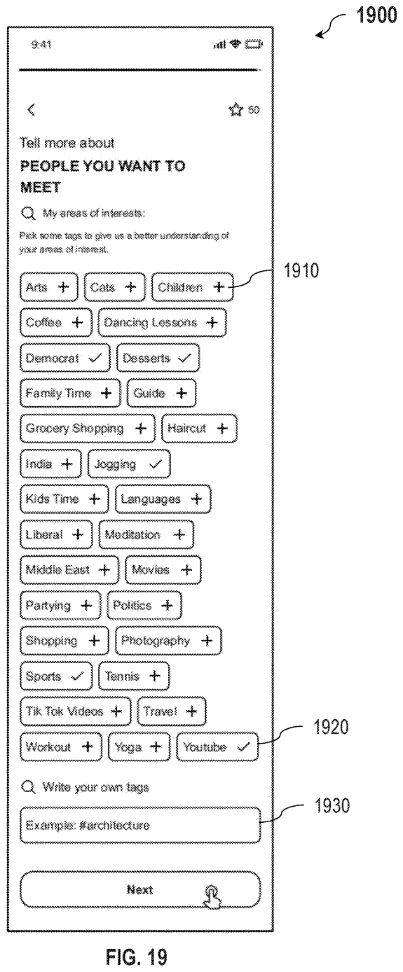

Turning to FIG. 19, illustrated is an exemplary screenshot 1900 from a mobile application, for use with a platform or service in accordance with the disclosed principles, presenting a user of the mobile application selection options from available search criteria for finding social prospects. In this embodiment, an AI engine has scraped one or more of the user's social media accounts and determined a plurality of characteristics the AI thinks would be of interest to the user if found in social prospects. As mentioned above, the AI engine can determine these potential interests by evaluating all of the information found in the user's integrated social media accounts.

As illustrated, the mobile application can permit the user to then select which characteristics the user fells are most important for him/her to find in potential social prospects. Such selected tags 1920 may then be given greater weight by the search engine of the disclosed platform or service when conducting searches for social prospects on behalf of the user. The user may also be given the ability to delete certain presented characteristics if the user believes those attributes are not of interest to him/her, or perhaps does not what them taken into account during a search for prospects. Additionally, a dialog box 1930 may be provided via the application so that users may input other characteristics not previously displayed. Any number of characteristics may be employed by the application and/or platform or service, as desired. Moreover, characteristics may be presented in separated categories, and presented on multiple pages, as needed or desired.

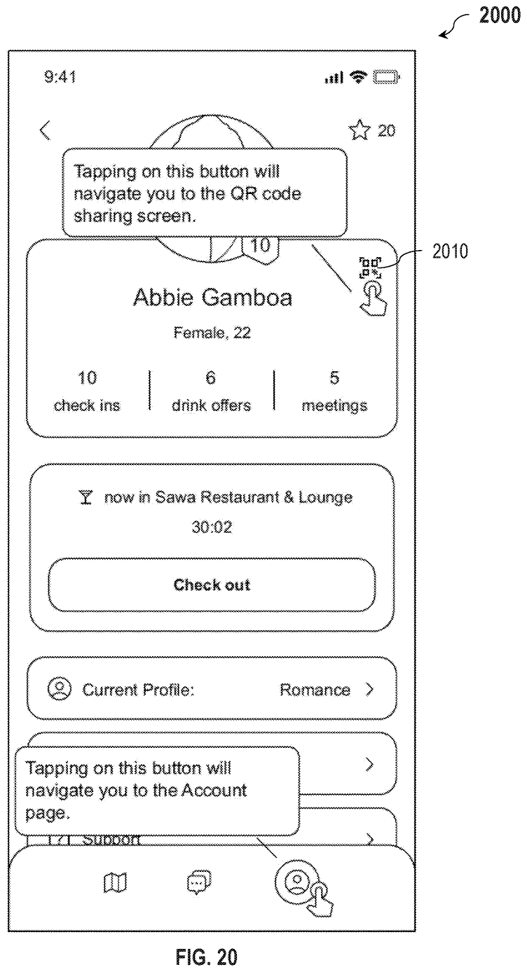

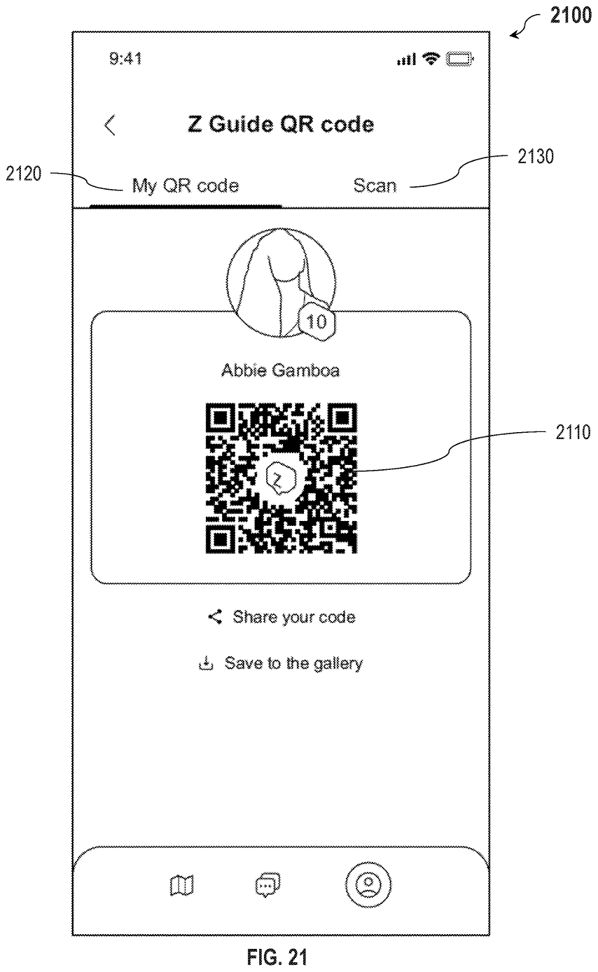

FIG. 20 illustrates an exemplary screenshot 2000 from a mobile application, for use with a platform or service in accordance with the disclosed principles, of the profile page of the user of the application who has checked in at a particular establishment. The illustrated profile page is similar to those discussed above; however, now an illustration of the selection of a QR code button 2010 is shown. Selecting the QR code button 2010 will open a new screen, shown in FIG. 21, or present a pop up screen that displays a QR code that is unique to this particular user.

Looking at FIG. 21, illustrated is an exemplary screenshot 2100 from the mobile application of a QR Code 2110 associated with the user of the mobile application shown in FIG. 20. Displaying the user's QR code 2110, e.g., via a “My QR code” tab or button, 2120, allows other users to scan their QR code 2110, which in turn can provide useful information about the user to the scanning user. This information may then be automatically saved in the mobile application of the scanning user or otherwise linked to the scanning user's application via connection to the platform or service. Also on this page is a “Scan” tab or button 2130 that permits this particular user to scan another user's QR code (not illustrated).

Such information may include, but is not limited to, personal details about the user (e.g., name, age, gender, sexual orientation, religion, etc.), contact information of the user (e.g., email address, phone number, physical address, etc.), interests of the user, characteristics associated with the user (e.g., determined by an AI engine for the user), current and historical activity of the user on the platform or service, reason(s) the user is on the platform or service, the user's occupation and perhaps work schedule, and any other information that may be useful or of interest to other users/social prospects on the platform or service. Also, users may have the ability to amend the information that is shared to other users via their QR code 2110. Further, certain categories of users on the platform or service may share only certain types of information via their QR code 2110. For example, workers or other people associated with a particular establishment may have just their first names and work schedule to scanning users so that their “regulars” will know when the person is working at their particular establishment. In a business networking embodiment, a user's QR code may be scanned by another business prospect such the user's occupation, position, work schedule, etc., may be provided to the scanning user, and perhaps also the type of business interest(s) the user is hoping to find in other prospects via the platform or service. In a child playmate embodiment, the user's QR code may be provide information to the scanning user such as the user's name or parent's name, the activities the child is participating in (and perhaps their schedule for such activities), the child's school information, the child's parent's preferred days, time and location for playdates, and any other information that would be useful for children to connect as friends or playmates via the platform or service.

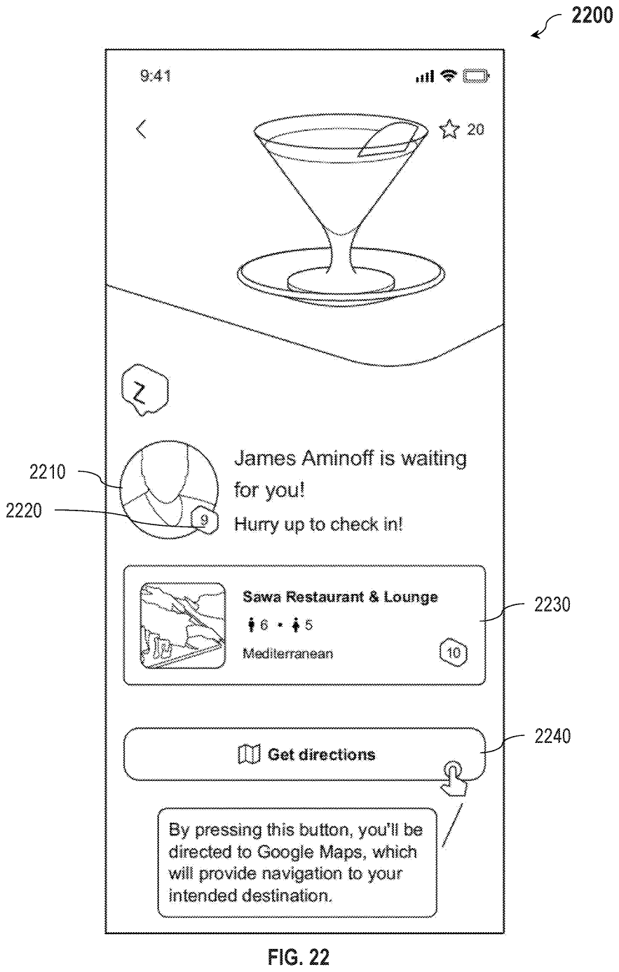

FIG. 22 illustrates an exemplary screenshot 2200 from a mobile application, for use with a platform or service in accordance with the disclosed principles, presenting the user of the mobile application a social prospect matching the search criteria of the user as well as their current location at an establishment. Such an exemplary screen of the application may provide images of the prospect 2210, the prospect's rating factor 2220, and the establishment at which the prospect is currently located 2230. Additionally, such a screen may inform a user if the prospect is “offering a drink”, “offering a cup of coffee”, or any other status information the prospect has elected to share. A “Get directions” button 2240 may also be provided so that the user can quickly receive directions, e.g., via a navigation application on the user's mobile device, to the establishment where the prospect is currently located. To obtain additional information about the prospect, the user may click or select the image of the prospect.

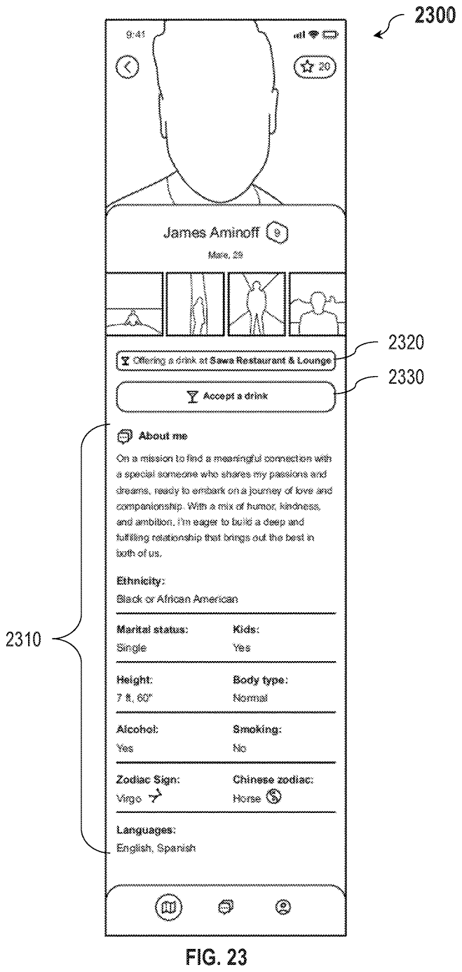

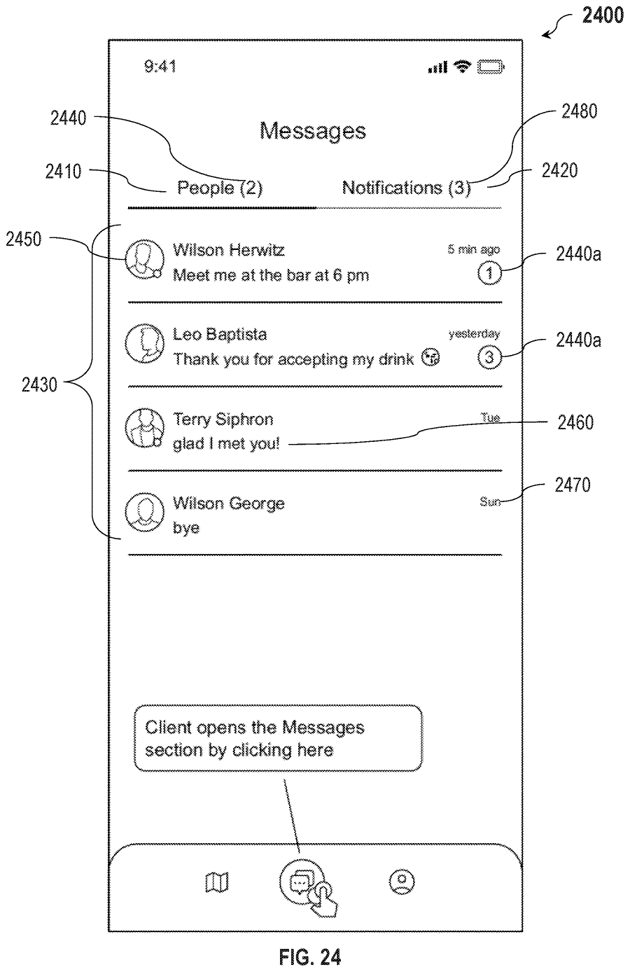

FIG. 23 illustrates an exemplary screenshot 2300 from the mobile application of FIG. 22 and which is presenting to the user of the mobile application a public profile of the social prospect of FIG. 22. The viewable profile of the prospect can provide the user a number of additional details 2310 about the prospect. Also, other images the prospect has elected to post on his profile may also be accessible to the user. This screen may also inform a user if the prospect is “offering a drink” 2320 or “offering a cup of coffee”. Additionally, the screen may permit the user to “Accept a drink” via button 2330, where doing so would send a message or notification to the prospect indicating the user's “acceptance” of a drink (or cup of coffee or to simply to meet up). Such an acceptance or similar communication from the user to the prospect may also allow messaging or other direct communication with the prospect, such as the messaging illustrated in FIG. 24 and discussed below. Alternatively or additionally, messaging with the prospect may be initiated by the user via a messaging button 2340 on the screen. A map button 2350 may also allow the user to get directions to the prospect's current location, as discussed above. A contacts button 2360 may also be provided on this and other screens discussed herein.

Turning finally to FIG. 24, illustrated is an exemplary screenshot 2400 from a mobile application of a messaging feature for the user of the mobile application to communicate with potential social prospects associated with a platform or service as disclosed herein. The Messages screen, which may be accessed by a button at the bottom of the screen, may include two tabs, a “People” tab 2410 and a “Notifications” tab 2420. When the People tab 2410 is selected, as illustrated, a list 2430 of social prospects the user has been messaging with is displayed. The label of the tab 2410 may also have an indicator 2440 indicating the number of prospects found in the list of people the user has messaged with, or it may indicate the number of unread messages 2440a from the list of prospects. In other embodiments, both may be indicated on the People tab 2410.

When the list of prospects is displayed, settings on the Messages screen may display not only the names of each of the prospects the user has messaged with, but also an image 2450 of the prospects, and perhaps a preview of the last message 2460 received from the prospects. As shown, emojis may also be available. Still further, the date and/or time 2470 of the messages exchanged with each of the prospects may also be displayed. Clicking on one of the prospects in the list can open a new page or produce a pop up window (not illustrated) that displays the entire conversation of messages with the selected prospect. Message conversations may be deleted or saved, or only certain messages may be deleted or saved.

When the Notifications tab 2420 is selected by the user, a list of notifications received by the user is displayed. For example, the notifications may include only prompts by prospects to the user, but in other embodiments the notifications may even include notifications from the platform or service as well. As with the People tab 2410, the Notifications tab 2420 may also have an indicator 2480 indicating the number of notifications found in the list of notifications, or it may indicate the number of unread notifications received from the user's prospects. In other embodiments, both may be indicated on the Notifications tab 2420.

### Exemplary Incentive System

Another advantage of a platform or service in accordance with the disclosed principles, and which may also be implemented via a mobile application as discussed above, is the use of an incentive system to assist users with finding and meeting potential social prospects. This incentive system functions as a type of virtual currency within the platform or service, and incentivizes users to be open and honest with other users, and to encourage good behavior and deter bad behavior on the platform or service. In exemplary embodiments, the incentive system can start each user with an introductory number of stars or any other type of points or currency, where users earn such stars by performing certain actions on the platform or service, and can lose stars by doing certain actions that are considered at least somewhat detrimental.

In some embodiments, the incentive currency is called “Z Stars”, keeping with the branding of “Z Guide” for the mobile application exemplary embodiment discussed in FIGS. 13A-24 above. Of course, any name may be adopted for the virtual currency or points implemented on a platform or service as disclosed herein. Looking briefly back at FIG. 16B, the exemplary embodiment disclosed therein illustrates a user starting with a default of 20 Z Stars, shown at the top-right corner of the application screen. In some embodiments, the beginning amount of Z Stars may be the maximum permitted, and users can only lose stars and earn them back via their actions on the platform or service. In other embodiments, users may start with a default number of Z Stars, and then can gain or lose stars to an ongoing number of Z Stars above or below that beginning number. In such embodiments, a maximum number of stars may be set, while in other embodiments, no maximum of potential stars a user may earn is set.

As shown in the exemplary embodiment of FIG. 16B, a user may earn one or more Z Stars by simply “checking in” at a particular establishment. This is considered positive or beneficial behavior since it involves the user being active on the platform or service, and in particular allows other users to know that the initial user has made public their presence at the establishment. Additionally, if the user not only checks in but also sets their status as desiring to “offer a drink” in general or to a particular user, the offering user may earn a predetermined number of Z Stars since this is activity that promotes social interaction on the platform or service. In some embodiments, offering a drink may be detrimental, for example, if the user is determined by the platform to offer too many drinks. Other actions that can cost users stars could be a lack of interaction on the platform, as well as ignoring some or any “offers” of a drink or cup of coffee, etc. by other users.

As also illustrated, if the user let's AI write their check in status, this may cost the user a certain number of stars since this may be considered lazy behavior, as opposed to the user taking the time to prepare a personalized status. Of course, in other embodiments, using an AI engine for taking some actions on the platform may be seen as helpful, and thus rewards the user with new stars. This could be if the user employs AI to conduct a search for potential social prospects, or employs AI to assist the user in setting up their profile so that they may be more attractive to other searching users. In other embodiments, these actions may be deemed detrimental in certain situations, and thus would cost the user a predetermined number of stars rather than earning stars. In some embodiments, the earning or costing of stars for certain actions may be determined by the platform or service on a user-by-user basis, based on the history of each user's actions on the platform.

Additional examples of behavior by a user that could cost that user stars could be if the user hides their age on their profile, does not provide a profile picture, or if the user is determined by other users (e.g., rated) to not look like their provided profile photo, and thus is seen as deceiving to other users. Conversely, users may earn stars by providing updated profile photos, which can be corroborated by the time/date, as well as location, capabilities of the user's mobile device. In some embodiments, a platform or service in accordance with the disclosed principles may require each user to provide a new profile photo, such as a “selfie”, every so often (e.g., one a year), and users may be rewarded for doing so. In such embodiments, facial recognition, AI, and other technologies may also be employed by the platform or service, such as through a mobile application as disclosed herein, to confirm that the photo is in fact of the user.

In some embodiments, establishments that are users of a platform or service as disclosed herein may also have an incentive-based system. For example, locations/establishments may be incentivized to use the platform (e.g., through a mobile application as discussed above or by another means) to encourage users to visit their establishments. Additionally, such encouragement may be a monetization opportunity for the platform or service. For example, establishments may pay a fee (single or recurring) to have their location promoted to users of the platform or service, and who are conducting a search for locations to meet potential social prospects. Also, establishments may, depending on their membership with the platform or service, advertise specials and events they may have. Such establishment users may also earn or lose stars in the virtual currency based on their activities (or lack thereof) on the platform. For example, establishments may earn stars by participating in promotions and for offering specials to users of the platform, but may lose stars for not regularly doing so. Still further, establishments may earn stars from users that visit their location, which may be by rating the establishments using any advantageous criteria. Establishments may even provide incentives to users for taking the time to rate an establishment, such as awarding free drinks or food, etc. in exchange for providing ratings. Similarly, establishments may lose stars if ratings provided by users are negative, but also gain stars if the ratings are positive.

### Exemplary Artificial Intelligence Implementations

Advantageously, most or all of the functionality of a platform, service and mobile application discussed above may be implemented or assisted by the use of artificial intelligence. Those skilled in the pertinent fields of art are knowledgeable about the development and use of artificial intelligence, and thus a detailed discussion of these will not be included here. However, the implementation of AI into some or all of the unique functionality of a platform or service designed or constructed in accordance with the disclosed principles results in novel applications and results. For example, as mentioned above, AI may be used by users of the disclosed platform or service to help draft the details of the profile, which would be visible to other users/social prospects. In such embodiments, AI may be used to examine other online information about the user creating an account, such as the uses various social media profiles. AI may not only do a better job of including all relevant information about the user that the user may forget to put in his new profile, but may also better present that information. Such better presentation may also be tailored to the user's purpose for using the platform or service, such as tailoring his profile for the best presentation to potential romantic prospects, or tailoring his profile for the best most professional presentation to potential business prospects he could meet on the platform.

Other potential implementations of AI for users creating or updating their profiles on the disclosed platform or service is the use of AI to help craft a message to a specific social prospect the user would like to meet. In such embodiments, the AI engine could examiner that prospect's profile in order to craft an ideal message to that person to meet/impress them, whether for romantic or business purposes, or perhaps even simply to find common activities to invite the person to do. In other similar implementations, AI may be used to update users' profiles based on what the AI determines might be more attractive to what other people using the platform or service seem to like or what they are or have been looking for when using the platform or service. In such embodiments, the AI engine may examine a user's profile and then make suggestions that the user could accept or reject, as desired. Similarly, AI may be implemented to update a user's profile based on what might be more attractive to another specific profile found by the user. For example, the user could select that found profile of a person they would like to meet, and then ask the AI to suggest changes to the user's profile to make user a better “match” for that person. Then, when that person searches on the platform or service for potential social prospect matches, there is a greater likelihood that the user's profile will be found in that search as a potential match.

In yet other implementations, AI could be used to suggest what locations during a user's geographic search for social prospects might be better to meet certain types of people. Such AI-based customization may be based on the user's past visitation history to certain establishments, the history of people/users that have visited certain establishments, and the history of the characteristics associated with the people that visit certain types of establishments. Also, AI may be implemented to find additional potential matches for a user once that user has previously found a matching prospects. For example, once a user finds a matching prospect, the user could query the AI to find additional people who are similar to the original matching prospect. The AI may also be implemented to suggest certain people as potential matches for a user based on that user's past searches for certain characteristics of people, such as age, interests, body types, whether they have children or not, income, job type, etc. In such embodiments, the AI may assist the user in finding certain characteristics in potential matches that the user did not realize they were attracted to. In short, AI may be implemented into facets of the disclosed principles to bolster the benefits and advantages of platforms and services as disclosed herein. In this respect, a platform or service as disclosed herein can provide users the unique and novel capabilities of searching for and finding potential social prospects, and AI can assist with that searching and finding in a manner that would provide benefits to users that their searches alone may not enjoy.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

1-20. (canceled)

21. A method, comprising:
electronically processing, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically processing a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof;
electronically processing, via the host application, a structured string of values comprising one or more input parameters, the structured string of values being received via the communications network in connection with a first in-memory configuration of the plurality of first in-memory configurations; and
electronically matching, for the first in-memory configuration, the one or more input parameters with one or more of the following: the respective first collection of elements; the respective second collection of elements; the aggregated data points; or any combination thereof, to compute a threshold number of the on-line representations of off-line establishment identities meeting a pre-determined matching criteria.

22. The method of claim 21, and further comprising calculating, for the computed threshold number of the on-line representations of off-line establishment identities, corresponding composite rating scores respectively comprising a first rating score and a second rating score, wherein:
the first rating score is being calculated based, at least in part, on the threshold number of the on-line representations of off-line establishment identities meeting the pre-determined matching criteria, the first rating score being a substantially objectively quantifiable value, and
the second rating score is being calculated based, at least in part, on input values received from the external data sources via the communications network for the computed threshold number of the on-line representations of off-line establishment identities meeting the pre-determined matching criteria, the second rating score being a substantially subjectively quantifiable value.

23. The method of claim 22, wherein:
the first rating score pertains to characteristics of particular off-line individual identities of the on-line representations of off-line individual identities located at the off-line establishment identities of the on-line representations of off-line establishment identities, the first rating score being based, at least in part, on one or more of the following: an artificial intelligence analysis; an independent third-party analysis; an industry-wide analysis; or any combination thereof, and
the second rating score pertains to the characteristics of the particular off-line individual identities of on-line representations of the off-line individual identities located at the off-line establishment identities, the second rating score being based, at least in part, on the input values provided via at least one of the following: a star rating; a numerical scale rating; a net promoter value rating; or any combination thereof, and on density of the particular off-line individual identities of the on-line representations of off-line individual identities located at the off-line establishment identities meeting the pre-determined matching criteria.

24. The method of claim 23, wherein the structured string of values comprises an electronic search query submitted in connection with the first in-memory configuration, and wherein the one or more input parameters comprise one or more of the following: desired characteristics of the particular off-line individual identities; a desired geographic location of the off-line establishment identities; a temporal parameter; or any combination thereof.

25. The method of claim 24, wherein the first in-memory configuration comprises an electronic profile of a searching user, and wherein the electronic matching comprises comparing personal characteristics of the searching user against the plurality of second in-memory configurations to identify establishments having a threshold number of socialization characteristics corresponding to the personal characteristics of the searching user, the comparing being based, at least in part, on one or more of the following: the electronic search query; the plurality of data points; the plurality of first in-memory configurations; the plurality of second in-memory configurations; or any combination thereof.

26. The method of claim 22, and further comprising:
recalculating, for the computed threshold number of on-line representations of off-line establishment identities, the respective composite rating scores based, at least in part, on the aggregated data points and an additional structured string of values received via the communications network, the recalculated threshold number of on-line representations of off-line establishment identities to be used, in whole or in part, in one or more subsequent electronic matching to update digital rendering of the on-line representations of off-line establishment identities via a graphical user interface (GUI) of the computing device, the aggregated data points comprising one or more of the following: real-time check-in data points; geolocation data points; one or more feedback scores from the external data sources; or any combination thereof.

27. The method of claim 22, further comprising:
ranking the computed threshold number of on-line representations of off-line establishment identities to generate an ordered set based, at least in part, on the corresponding composite rating scores; and
electronically providing the ordered set for use by the host application of the computing device on the communications network.

28. The method of claim 22, wherein the external data sources comprise authorized data sources, and wherein the aggregated data points are used, at least in part, for one or more of the following: supplementing the first rating score; updating the threshold number of the on-line representations of off-line establishment identities meeting the pre-determined matching criteria; or any combination thereof.

29. The method of claim 22, and further comprising:
electronically processing one or more particular data points of the plurality of data points received in real time from one or more external data sources via the communications network, the one or more data points comprising one or more of the following: real-time attendance data points; verified geographic location data points; one or more evaluation scores from one or more remote user devices; or any combination thereof; and
recalculating the respective composite rating scores for particular off-line establishment identities of the on-line representations of off-line establishment identities based, at least in part, on the one or more data points received in real time, wherein the updated respective composite rating scores are being used, at least in part, for subsequent one or more matching operations to update the particular off-line establishment identities of the on-line representations of off-line establishment identities digitally rendered via a GUI in response to processing one or more additional structured strings of values received via the communications network.

30. The method of claim 22, and further comprising:
electronically implementing one or more ranking operations to generate a first ordered set of on-line representations of off-line establishment identities based, at least in part, on the composite rating scores computed for respective on-line representations of off-line establishment identities;
electronically implementing one or more additional ranking operations to generate a second ordered set of on-line representations of off-line individual identities based, at least in part, on a computed relevance metric corresponding to respective on-line representations of off-line individual identities, the computed relevance metric being computed via one or more of the following: a computed frequency metric of data points associated with a given on-line representation of an off-line individual identity corresponding to one or more of the on-line representations of off-line establishment identities of the first ordered set; one or more elements of the first collection of elements of a given on-line representation of an off-line individual identity satisfying a threshold number of pre-determined matching criteria corresponding to the first in-memory configuration; one or more temporal data points associated with a given on-line representation of an off-line individual identity corresponding to one or more of the on-line representations of off-line establishment identities of the first ordered set; or any combination thereof; and
electronically communicating one or more digital signals comprising the first ordered set and the second ordered set to a requesting remote user device via the communications network.

31. The method of claim 22, wherein the one or more aggregation operations on the plurality of data points further comprise electronically processing one or more data points from one or more third-party external data sources via the communications network, the one or more data points comprising one or more of the following: geographic data points; visit data points; demographic characteristic data points; socioeconomic characteristic data points; or any combination thereof, and pertaining to one or more particular off-line individual identities of the on-line representations of off-line individual identities, wherein the one or more data points from the one or more third-party external data sources are part of the computation operation of the first rating score of the particular composite rating score.

32. The method of claim 21, wherein the plurality of data points comprises one or more of the following: quantitative data points; qualitative data points; or any combination thereof, and wherein the external data sources comprise one or more remote user devices.

33. The method of claim 21, wherein:
the plurality of first in-memory configurations comprises electronic user profiles,
the first in-memory configuration comprises a user profile, and
the respective first collection of elements comprises respective personal characteristics of the user profile.

34. The method of claim 21, wherein:
the plurality of second in-memory configurations comprises electronic establishment profiles, and
the respective second collection of elements comprises respective sets of socialization characteristics of an establishment profile.

35. The method of claim 21, wherein the plurality of first in-memory configurations comprises a plurality of electronic profiles respectively comprising a digital set of values indicative of personal characteristics pertaining to corresponding off-line individual identities, and the plurality of second in-memory configurations comprises a plurality of electronic establishment profiles respectively comprising a digital set of values indicative of socialization characteristics pertaining to a particular on-line representation of an off-line establishment identity.

36. The method of claim 21, wherein the plurality of data points comprises electronically verified venue attendance data, and the one or more aggregation operations comprise aggregating the electronically verified venue attendance data based, at least in part, on one or more of the following: electronically verified historical attendance data; electronically verified real-time attendance data; electronically verified third-party database data; or any combination thereof.

37. The method of claim 21, wherein the structured string of values comprises an electronic search query, and wherein the one or more input parameters comprises one or more of the following: one or more key terms defining the digital set of values indicative of personal characteristics pertaining to an off-line individual identity; one or more temporal parameters; one or more geographic parameters; or any combination thereof.

38. The method of claim 21, wherein the first set-data structure of the first in-memory configuration comprises one or more elements of the first collection of elements corresponding to one or more socialization attributes of a particular on-line representation of an off-line individual identity.

39. The method of claim 21, and further comprising:
computing one or more evaluation scores of a plurality of evaluation scores received from one or more remote user devices corresponding to on-line representations of off-line individual identities having one or more elements of the first collection of elements corresponding to one or more personal characteristics of the first in-memory configuration; and
electronically associating, via the host application, the one or more evaluation scores with one or more temporal parameters comprising one or more of the following: a date parameter; a time parameter; a day-of-week parameter; or any combination thereof,
wherein the one or more evaluation scores account for one or more contextual attributes at a particular on-line representation of an off-line establishment identity communicated via the one or more remote user devices via the respective evaluation scores.

40. The method of claim 21, and further comprising electronically communicating one or more digital signals to a requesting remote user device via the communications network, the one or more digital signals are being processed to digitally render a map-type graphical user interface (GUI) comprising one or more graphical elements corresponding to one or more of the following: particular off-line individual identities of the on-line representations of off-line individual identities; particular off-line establishment identities of the on-line representations of off-line establishment identities; or any combination thereof.

41. The method of claim 21, and further comprising computing one or more geographic location data points corresponding to particular off-line individual identities of the on-line representations of off-line individual identities based, at least in part, on historical attendance data points of the plurality of data points corresponding to prior attendance data points by the respective on-line representations of off-line individual identities to one or more particular off-line establishment identities of the on-line representations of off-line establishment identities.

42. The method of claim 41, wherein the one or more geographic location data points corresponding to particular off-line individual identities of the on-line representations of off-line individual identities associated with one or more of particular off-line establishment identities of the on-line representations of off-line establishment identities comprises predicted geographic location data points computed based, at least in part, on one or more aggregation operations on historical attendance data points of the plurality of data points accounting for prior visits by the respective on-line representations of off-line individual identities to the respective on-line representations of off-line establishment identities.

43. The method of claim 21, wherein one or more geographic location data points corresponding to particular off-line individual identities of the on-line representations of off-line individual identities comprise real-time geographic location data points derived from one or more data points of the plurality of data points received in real time from one or more remote user devices corresponding to the respective on-line representations of off-line individual identities via the communications network.

44. The method of claim 21, and further comprising:
electronically implementing one or more matching operations on the plurality of data points to identify one or more particular off-line establishment identities of the on-line representations of off-line establishment identities having a concentration of on-line representations of off-line individual identities satisfying a threshold number of pre-determined matching criteria corresponding to the first in-memory configuration, based at least in part on one or more of the following: real-time attendance data points; predicted attendance data points; historical attendance data points corresponding to one or more temporal parameters; or any combination thereof; and
electronically communicating one or more digital signals to a requesting remote user device via the communications network, the one or more digital signals to facilitate digital rendering of the identified one or more on-line representations of off-line establishment identities with elevated prominence within a GUI of the requesting remote user device.

45. The method of claim 21, and further comprising:
electronically processing one or more digital signals received from a first remote user device and corresponding to the first in-memory configuration, the one or more digital signals comprising a structured communication message processed for transmission to a second remote user device and corresponding to the first in-memory configuration associated with a determined on-line representation of off-line individual identity, the structured communication message being directed to at least one particular off-line individual identity of the on-line representations of off-line individual identities; and
electronically forwarding one or more digital signals comprising a response communication message received from the second remote user device to the first remote user device via the communications network.

46. The method of claim 21, and further comprising:
electronically generating a unique machine-readable identifier element associated with the first in-memory configuration; and
upon electronically processing one or more digital signals received from a second remote user device corresponding to a digital scan of the unique machine-readable identifier element, transmitting one or more elements of the first collection of elements of the first in-memory configuration to the second remote user device and one or more elements of another collection of elements of an additional first in-memory configuration to a first remote user device via the communications network.

47. The method of claim 21, and further comprising:
electronically processing one or more digital signals from a requesting remote user device, the one or more digital signals comprising one or more data points confirming a current geographic location of the first in-memory configuration at a particular off-line establishment identity of the on-line representations of off-line establishment identities;
computing one or more evaluation scores and one or more contextual attribute data points received from the requesting remote user device based, at least in part, on the confirmation of the current geographic location; and
storing as one or more digital signals the one or more evaluation scores and the one or more contextual attribute data points in association with one or more temporal parameters and one or more elements of the first collection of elements of the first in-memory configuration.

48. The method of claim 21, and further comprising:
electronically processing one or more digital signals from a first remote user device corresponding to the first in-memory configuration associated with a determined on-line representation of off-line individual identity currently located at a particular off-line establishment identity of the on-line representations of off-line establishment identities, the one or more digital signals comprising an invitation communication directed to one or more further on-line representations of off-line individual identities;
electronically transmitting the invitation communication to a requesting remote user device and corresponding to the first in-memory configuration via the communications network;
electronically processing one or more digital signals from the requesting remote user device and comprising an acceptance message responsive to the invitation communication; and
electronically transmitting the acceptance message to the first remote user device via the communications network.

49. An apparatus, comprising:
a processor coupled to a memory of at least one computing device, the processor to:
electronically process, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically process a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof;
electronically process, via the host application, a structured string of values comprising one or more input parameters, the structured string of values being received via the communications network in connection with a first in-memory configuration of the plurality of first in-memory configurations; and
electronically match, for the first in-memory configuration, the one or more input parameters with one or more of the following: the respective first collection of elements; the respective second collection of elements; the aggregated data points; or any combination thereof, to compute a threshold number of the on-line representations of off-line establishment identities meeting a pre-determined matching criteria.

50. The apparatus of claim 49, wherein the processor is further to calculate, for the computed threshold number of the on-line representations of off-line establishment identities, corresponding composite rating scores respectively comprising a first rating score and a second rating score, wherein:
the first rating score is being calculated based, at least in part, on the threshold number of the on-line representations of off-line establishment identities meeting the pre-determined matching criteria, the first rating score being a substantially objectively quantifiable value, and
the second rating score is being calculated based, at least in part, on input values received from the external data sources via the communications network for the computed threshold number of the on-line representations of off-line establishment identities meeting the pre-determined matching criteria, the second rating score being a substantially subjectively quantifiable value.

51. The apparatus of claim 49, wherein:
the first rating score pertains to characteristics of particular off-line individual identities of the on-line representations of off-line individual identities located at the off-line establishment identities of the on-line representations of off-line establishment identities, the first rating score being based, at least in part, on one or more of the following: an artificial intelligence analysis; an independent third-party analysis; an industry-wide analysis; or any combination thereof, and
the second rating score pertains to the characteristics of the particular off-line individual identities of on-line representations of the off-line individual identities located at the off-line establishment identities, the second rating score being based, at least in part, on the input values provided via at least one of the following: a star rating; a numerical scale rating; a net promoter value rating; or any combination thereof, and on density of the particular off-line individual identities of the on-line representations of off-line individual identities located at the off-line establishment identities meeting the pre-determined matching criteria.

52. An article, comprising:
a computer-readable medium having stored thereon instructions executable by a computing device to:
electronically process, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically process a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof;
electronically process, via the host application, a structured string of values comprising one or more input parameters, the structured string of values being received via the communications network in connection with a first in-memory configuration of the plurality of first in-memory configurations; and
electronically match, for the first in-memory configuration, the one or more input parameters with one or more of the following: the respective first collection of elements; the respective second collection of elements; the aggregated data points; or any combination thereof, to compute a threshold number of the on-line representations of off-line establishment identities meeting a pre-determined matching criteria.

53. The article of claim 52, wherein the instructions are further to calculate, for the computed threshold number of the on-line representations of off-line establishment identities, corresponding composite rating scores respectively comprising a first rating score and a second rating score, wherein:
the first rating score is being calculated based, at least in part, on the threshold number of the on-line representations of off-line establishment identities meeting the pre-determined matching criteria, the first rating score being a substantially objectively quantifiable value, and
the second rating score is being calculated based, at least in part, on input values received from the external data sources via the communications network for the computed threshold number of the on-line representations of off-line establishment identities meeting the pre-determined matching criteria, the second rating score being a substantially subjectively quantifiable value.
